(19) United States
(12) Patent Application Publication
(10) Pub. No.: US 2006/0033992 A1
(43) Pub. Date: Feb. 16, 2006

(54) Advanced integrated scanning focal immersive visual display

(76) Inventor: Dennis J. Solomon, Yarmouth Port, MA (US)

Correspondence Address: Dennis J. Solomon, PO Box 289, Yarmouth Port, MA, 02675-0289, US

(21) Appl. No.: 11/149,638

(22) Filed: Jun. 9, 2005

Related U.S. Application Data
(63) Continuation-in-part of application No. 10/307,620, filed on Dec. 2, 2002, now abandoned.

(51) Int. Cl. G02B 27/22

(52) U.S. Cl. 359/462

(57) ABSTRACT

The present invention discloses an improved method and device for the display of a three-dimensional image with visual accommodation, including an improved method for manufacturing a visual display incorporating a scanned light source. An improved method of presenting visual information is also disclosed.

### TECHNICAL FIELD

This invention relates generally to display devices and more particularly to 3D imaging displays devices having an optional variable visual image distance. This application incorporates by reference my related and earlier filed applications and disclosures, and claims the continuation-in-part benefit of Ser. No. 10/207,620; which is a CIP of Ser. Nos. 10/941,461 and 10,172,629; which are CIP of 9,706,260, which is a CIP of U.S. Pat. No. 8,074,398; which is a CIP of U.S. Pat. No. 7/799,066 and benefits from the non-provisional application No. 60/584,351,

### BACKGROUND ART

Planar displays such as CRTs, LCD panels, laser scan and projection screens are well-known. These displays present an image at a fixed focal length from the audience. The appearance of three-dimensionality is a visual effect created by perspective, shading and occlusion and motion parallax. Integral photographic displays and lenticular autostereoscopic displays are also well-known, with a history that extends back at least 100 years. Miniature and head mounted displays (HMDs) are also well known and may involve a miniaturized version of the planar display technologies. In recent years, stereoscopic or 3D displays, which display a spatially distinct image to each eye, have enjoyed an increasing popularity for applications ranging from fighter pilot helmet displays to virtual reality games. The 3D HMD display technology has numerous extensions including Near-to-Eye (NTD)—periscopes and tank sights; Heads-Up (HUD)—windshield and augmented reality—and immersive displays (IMD)—including CAVE, dome and theater size environments. The principal employed varies little from that of the 1930 Polaroid™ glasses, or the barrier stereoscopic displays of the 1890s, despite. extensive invention related to the active technology to produce each display has occurred over the past twenty years. As applied to small displays, these techniques evolved from miniature cathode ray tubes to include miniature liquid crystal, field emission and other two-dimensional matrix displays, as well as variations of retinal scanning methodologies popularized by Reflection Technologies, Inc. of Cambridge, Mass. in the 1980s. Other approaches include scanning fiber optic point sources such as disclosed by Palmer, U.S. Pat. No. 4,234,788, compact folded, total internal reflection optical displays disclosed by Johnson in U.S Patent 4,109,263. These inventions have provided practical solutions to the problem of providing lightweight, high resolution displays but are limited to providing a stereoscopic view by means of image disparity. Visual accommodation is not employed.

A solution to the problem of accommodation for all displays was disclosed by A. C. Traub in U.S. Pat. No. 3,493,390, Sher in U.S. Pat. No. 4,130,832, and others. These inventors proposed a modulated scanning signal beam coordinated with a resonantly varying focal length element disposed in the optical path between the image display and the observer.

It is well known in the field that wavefront-based technologies, which by definition are limited to coherent effects, impart significant specular and other aberrations degrading performance and inducing observer fatigue.

Alternative approaches where a data-controlled, variable focal length optical element was associated with each pixel of the display were such of experimentation by this inventor and others, including Sony Corporation researchers, in Cambridge, Mass. during the late 1980s. In 1990, Ashizaki, U.S. Pat. No. 5,355,181, of the Sony Corporation, disclosed an HMD with a variable focus optical system.

Despite the improvements during the past decade, the significant problem of providing a low cost, highly accurate visual display with full accommodation remains. One of the principal limitations has been the inability of sequentially resonant or programmed variable focal length optics combined with scanning configurations to properly display solid three dimensional pixels, orthogonal to the scanning plane. Another limitation is the inability of the observer's eye to properly and comfortably focus on rapidly flashing elements. Numerous inventions have been proposed which have generally been too complicated to be reliable, too expensive to manufacture, without sufficient resolution, accuracy, stability to gain wide acceptance. The present invention solves these problems, particularly related to the accurate display of solid and translucent 3D pixels.

### BRIEF SUMMARY OF THE INVENTION

The present invention discloses an improved method and device for the display of a three dimensional image including stereoscopic and/or visual accommodation.

Another object of the present invention is an improved method and device for manufacturing a visual display incorporating a scanned light source,

Another object of the present invention is an improved method and device which permits image 3D pixel sources to be arranged orthogonally to image plane thereby enabling the display of an undistorted orthogonal surface or translucent solid,

Another object of the present invention is an improved method and device for constructing an accurate, augmented reality, visual display with automatic biocular alignment,

Another object of the present invention is an improved method and device for constructing an accurate, augmented reality, visual display without an intermediate image plane,

Another object of the present invention is an improved method and device for constructing an accurate, augmented reality, visual display where the principal scene object axis converge at a virtual point in a plane behind that describe by the lens of the eye.

Another object of the present invention is an improved method and device for manufacturing a visual display independent of coherence and wavefront curvature constraints,

Another object of the present invention is an improved method and device for manufacturing a visual display where the principal virtual object image axes converge in a plane behind that described by the lenses of the eye's of the observers,

Another object of the present invention is an improved method of presenting visual information,

Another object of the present invention is an improved method and device to present visual information in compact form unaffected by an external environment,

### BRIEF DESCRIPTION OF THE DRAWINGS

The above and still further objects, features and advantages of the present invention will become apparent upon consideration of the following detailed disclosure of specific embodiments of the invention, especially when taken in conjunction with the accompanying drawings, wherein:

FIG. 1 presents a general view of binocular stereoscopic viewers.

FIG. 2 presents a cross-sectional view of a stereo viewer.

FIG. 3 presents a cross-sectional view of an encoded driver.

FIG. 4 presents a cross-sectional view of a rotating mirror embodiment.

FIG. 5 presents a cross-sectional view of an interlaced array.

FIG. 6 presents a cross-sectional view of a cylindrical embodiment.

FIG. 7 presents a cross-sectional view of a light emitting element (LEE) array.

FIG. 8 presents a cross-sectional view of a reflecting chamber.

FIG. 9 presents a cross-sectional view of a multiple LEE arrays.

FIG. 10 presents a cross-sectional view of a tricolor waveguides.

FIG. 11 presents a cross-sectional view of a prismatic color system.

FIG. 12 presents a cross-sectional view of a thin waveguide screen.

FIG. 13 presents a cross-sectional view of a lenticular screen.

FIG. 14 presents a cross-sectional view of a block diagram of the interfaces between components.

FIG. 15 presents a cross-sectional view of a rotating polygon embodiment.

FIG. 16 presents a cross-sectional view of a FDOE.

FIG. 17 presents a cross-sectional view of an interlaced TIM.

FIG. 18 presents a cross-sectional view of a FDOE and TIM.

FIG. 19 presents a crosszsectional view of a Dove prism embodiment.

FIG. 20 presents a cross-sectional view of a piezo-optic FDOE.

FIG. 21 presents a perspective view of a scanning reflector stereo viewer.

FIG. 22 presents a scanning stereo viewer using micro optic domains with a polarizing aperture

FIG. 23 presents a scanning stereo viewer using plasma cavity

FIG. 24 presents a lenticular screen viewer field stereo viewer

FIG. 25 shows a perspective view of a display embodiment of the present invention,

FIG. 26 shows a top view of a head mounted display embodiment of the present invention,

FIG. 27 shows a perspective view of the linear array, continuous focal distance embodiment of the present invention,

FIG. 28 shows a top view of the linear array, continuous focal distance embodiment of the present invention with scanning elements,

FIG. 29 shows a top view of the planar array, continuous focal distance embodiment of the present invention,

FIG. 30 shows a top view of the planar array, continuous focal distance embodiment of the present invention applied to an autostereoscopic display,

FIG. 31 shows a top view of the planar array, continuous focal distance embodiment of the present invention applied to a head mounted display,

FIG. 32 shows a perspective view of a two photon activation embodiment of the present invention,

FIG. 33 shows a perspective view of a plasma activation embodiment of the present invention,

FIG. 34 shows a perspective view of a deflected, tethered light emitting element activation embodiment of the present invention,

FIG. 35 shows a perspective view of a three dimensional acousto-optic deflection of apparent light source embodiment of the present invention.

FIG. 36 shows a perspective view of the virtual convergence points of the principal axis of the scene objects behind the plane of the lens of the eye in the present invention.

FIGS. 37-44 presents a preferred embodiment of the present invention.

FIGS. 45-58 presents a preferred waveguide embodiment of the present invention

FIGS. X1-X2 presents a preferred augmented display embodiment of the present invention

### DETAILED DESCRIPTION OF THE INVENTION

Certain components of the present invention are common to most of the embodiments presented and are referred to by acronyms as follows:

A LEE (light emitting element) or “LEE array” refers to a matrix of LEDs (light emitting diodes), OLED, PLD, LCD (liquid crystal display), plasma elements, film projector or other means of projecting an array of image pixels. A LEE array may be linear, planar, a curved surface or other array in space. A linear array is commonly used throughout for convenience, but in most cases may be substituted by an other form.

A TIM (transduced-interlaced-means) refers to a means to direct the output of a LEE to a subset array of a full view. A TIM should not obscure the subsets. Examples include a microlens array, an optical funnel array incuding waveguides and fiber optics, a reflective mask, a diffraction array, holographic optical element or other known approach. The optical components may be physically or optical transduced by electro-optic, acoustic, piezo-optic, SLMs or other known means. Examples include, but are not limited to, mechanical piezo-actuators such as manufactured by Piezo Systems, Inc., acousto-optic beam direction modulators manufactured by Neos, Inc., liquid crystal variable diffractors manufactured by Dupont or active reflector pixels manufactured by Texas Instruments.

An FDOE (focal distance optical element) refers to a means for controlling the observedfocal distance of the image or image pixel. The absence of this optical effect in many stereo systems induces a perceptual anomaly where the visual convergence and accommodation are in conflict. Auto-stereoscopic devices are known to have employed variable curvature reflectors, rotating asymmetric lenses, electronically or acoustically controlled optical materials, holographic optical elements and other technologies to achieve full frame focal distance control. These may be employed in the present invention. For individual point focus, it is important that the surrounding environment be unfilled or neutral to the point of attention. Thus the eye will find the best focus and rest at the corresponding distance. This effect may be imparted by means of a surrounding mask, interlacing, or image control.

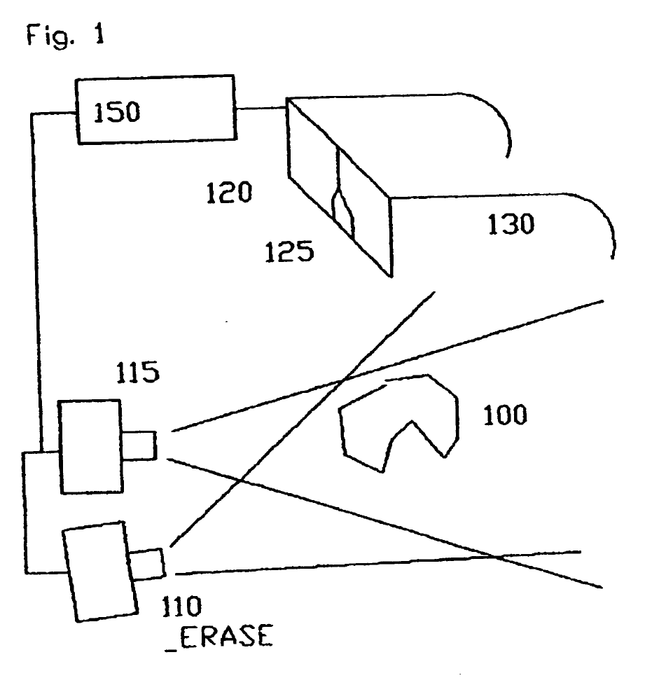

Referring to FIG. 1, a stereo viewing system generally presents the image of an object 100 taken by two cameras 110 and 115, displaced by a small distance equivalent to the separation of a viewer's eyes, to tv-type viewer panels 120 and 125, which corresponds to the view that would be seen by each eye. Commonly, the viewer panels 120 and 125 are mounted on an eyeglass or goggle-type frame. Alternatively, the images are presented combined on a single screen which is modulated in time, color or polarization by techniques well known. A stereo viewing system also commonly includes a link 140 between the cameras 110 and 115 and a processing computer, and a link 150 to the viewer panels 120 and 125. These links are often electronic, fiber optic, radiofrequency, microwave, infrared or other known method. The system does not have to be directly connected and storage media such as optical disks, film, digital tape, etc. may be used.

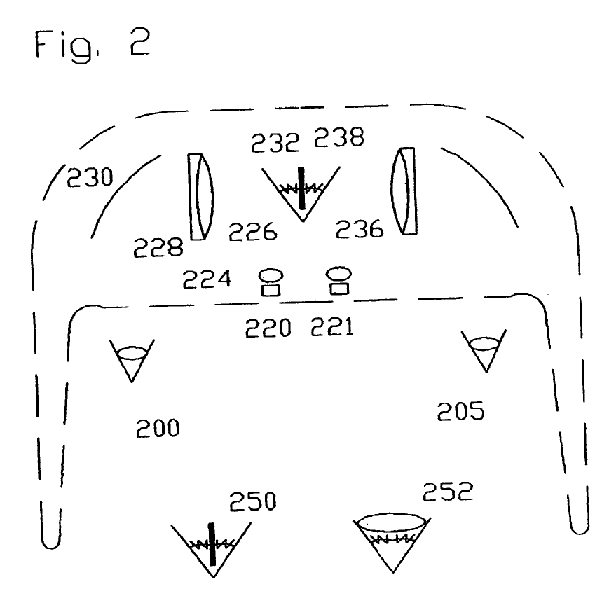

FIG. 2 presents a top component view of a preferred goggle-type embodiment of the present invention. Only one side of the embodiment will be described with the understanding that the opposite side is a mirror image. The viewer's eyes are represented by icons 200 and 205, left and right, respectively. The outline of the goggle is represented by dashed line 210. The visible image is produced by viewing the light output of the light-emitting element array (LEE) 220 and 221 through first optical component 224, reflected off of translocation mirror 226, through second optical component 228, reflected off of reflective surface 230, and viewed by left eye 200. The LEE 220 may be placed in or above the plane of the eyes, proximally or distally to the nose. The other components of the optical path are adjusted accordingly. The reflective surface 230 may be a white screen surface or more efficiently, a mirrored surface, either continuous or of micro domains with binary, diffractive, microcast or other elements, having a generally elliptical focal shape such that the image of the LEE 220 is projected to the eye 200 of the observer. In such a precise system, an adjustment of the eye position would be incorporated in the design. An optional optical eyepiece 240 may be introduced to enhance certain domains. An elliptically (circularly) polarized window 242 with anti-reflection coating may form the exit aperture thus reducing the spurious reflections caused by external ambient light. This technique may be applied to all of the following embodiments. In operation, a complete image is created by the translocation of mirror 226 cyclically at rates in excess of image rate of 30 Hz while presenting successive sections of the image on LEE 220.

The components may be employed a variety of structures well known. The LEE 220 may be a linear, planar, offset, spaced or curved surface matrix of LEDs, LCD, plasma, ELL, CRT, or known method of producing an image. The optical component 224 may be made from plastic, glass or other optical material. The optical properties may be imparted by classical lens designs, prisms, fresnel, HOE (holographic optical elements), or other known technologies. Active optical elements such as electro- (including but not limited to LCD, FLCD, deformable surface tension), acoustic, optical or piezo-optical components may also be employed.

The translocation mirror 226 may be driven by a voice-coil type driver 232. Overall system balance of inertia and momentum may be accomplish by an equal and opposite driver 234 acting simultaneously on mirror 236 for the opposite eye 205. Both drivers 232 and 234 may be connected to a base 238 to provide stable and absolute registration. Other driver systems may be employed including piezo-mechanical actuators 250, rotary cams 252, variable pressure and other known systems.

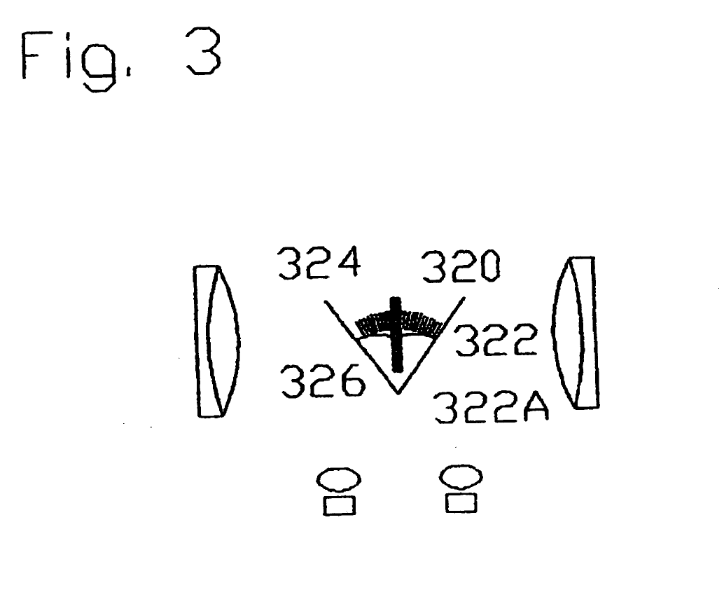

Referring to FIG. 3, the absolute registration of the images presented in the stereo viewer may be accomplished by employing an absolute or incremental encoder mechanism 310 such as an IR beam, proximity sensor, etc., monitoring the translocation mirror 326. One embodiment of the this method mounts the encoder beam and reading element 320 on a central base, the encoder lines 322 are fixed relative to the encoder element 320. A reflector 324 (not shown) directs the encoder beam to and from the translocation mirror 326. Alternatives include placing the encoder lines 322a on the mirror 326 which are read by an encoder mounted to intersect the transplanted path. Other systems include the use of interference fringes produced by coherent beam interactions or HOE elements. These systems are employed in other positioning systems.

Another preferred embodiment employing a rotating mirror and waveguide image plate is presented in FIG. 4. This method creates a visible image on the eye-side 410 of a waveguide/microlens plate 412 of the LEES 420 and 422. The components are one or more LEES 420 and 422, one or more focusing optical elements 424 and 426, a rotating reflector 430 of one or more reflective surfaces, a position encoder 432 related to the rotating reflector 430, a waveguide/microlens array 412, image optic elements 440, an image reflector 450. The viewer's eyes are represented by icon 460 and 462. The rotating reflector 430 may incorporate different displacement domains by means of micro optic regions, HOE, wedge or other known means, to increase the effective LEE 420 resolution and efficiency,

In operation, a section of the full view is illuminated by LEE 420. The image of LEE 420 is focused by optical elements 424 and reflected by rotating reflector 430 onto the entrance apertures of waveguide 412. The image of LEE 420 exits on surface 410 and is viewed by eye 460 through reflector 450 and optical elements 440. The rotating reflector moves one increment which is encoded by encoder 432 and initiates the presentation of the next corresponding section of the full view on LEE 420. In a stereo system with a double-sided rotating reflector 430, LEE 422 may simultaneously present a corresponding section of the view to the opposite eye 462. As the rotating reflector 430 rotates, sections are presented to alternating eyes. All rotating scanning embodiments may incorporate a HOE, binary optic or other optic element on one of more faces of the scanning face, the rotating mirror 426, such that the image of the LEE 420 is displaced coaxially relative to the other faces. This approach functions as a transducing system to increase the resolution from a given LEE array. It may also be understood that the LEE array may include one or more columns positioned adjacent,to LEE420. An optional mask and transducer 470 may be affixed to the LEE 420.

Not shown but well understood by those skilled in the art are the computer control electronics, memory, and driver circuitry needed to interface the rotating mirror, encoder, and LEES.

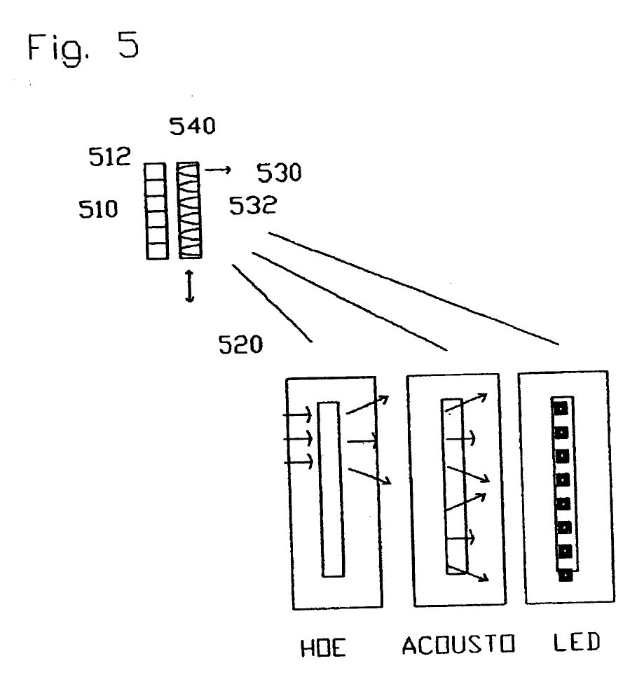

FIG. 5 presents the general concept of a transduced interlacing means. In operation, the output of the LEE array 510 traverses the TIM 530 and is masked or redirected. The output from single LEE element 512 is funnelled by optical funnel TIM 532 into a narrower beam. When the TIM 530 is transduced or translocated by transducer 540, the single LEE element 512 will produce a series of discrete output beams. By coordinating the LEE output with the TIM transduction, a higher visual resolution may be achieved than from the LEE array alone.

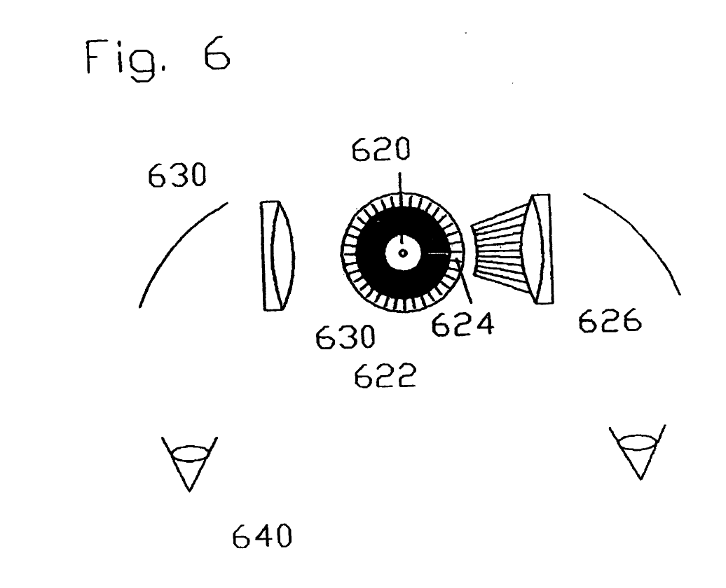

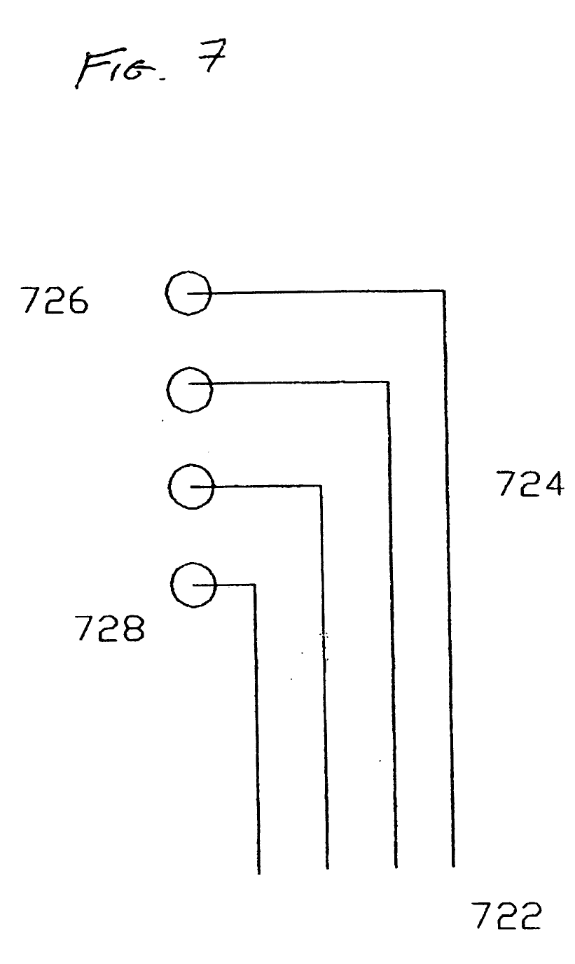

FIG. 6 presents another embodiment of a rotating optical element stereo view. This embodiment employs a rotating slit, pattern or waveguide port 624 to transfer the section of a full view to the viewer's eye. The port 624 may include optical elements to focus or transfer the beam. The components employed are a central LEE 620 which may be constructed as a vertical post of horizontal LEDs, or other light emitting elements, a rotating cylinder 622 which surrounds the LEE 620, an exit port 624 which presents the LEE 620, an optical element 626 with an optional waveguide array, an encoder 630 related to the rotating cylinder 622 and a reflector 630. The viewer's eye is represent by icon 640.

In operation, the central LEE 620 presents a section of the full view which is projected to the viewer's eye 640 by exiting the port 624 of the rotating cylinder 622, traversing the optical elements 626 which flatten the field and focus the LEE 620 or the port 624 image, and reflected by reflector 630. While synchronizing circuitry may be limited to a single encoded reference and speed control, a full absolute or incremental encoder may be affixed to the rotating cylinder 622. Successive sections of the full view are incrementally presented on the LEE 620 as the rotating cylinder 622.

FIG. 7 presents an alternative embodiment of the LEE 622. A horizontal array 722 of LEDs or other light emitting elements is formed in a vertical post 726 by a series of optical waveguides 724. The output 728 of each waveguide may subtend a limited solid angle or be essentially circumferential. In a single port system of FIG. 6, a broad circumferential output 728 would be simple. In a multiple port system, a multiple number of arrays 722 may be utilized with corresponding waveguides and optics. The advantages of multiple systems include high resolutions, slower translocation speeds, and less critical optical tolerances.

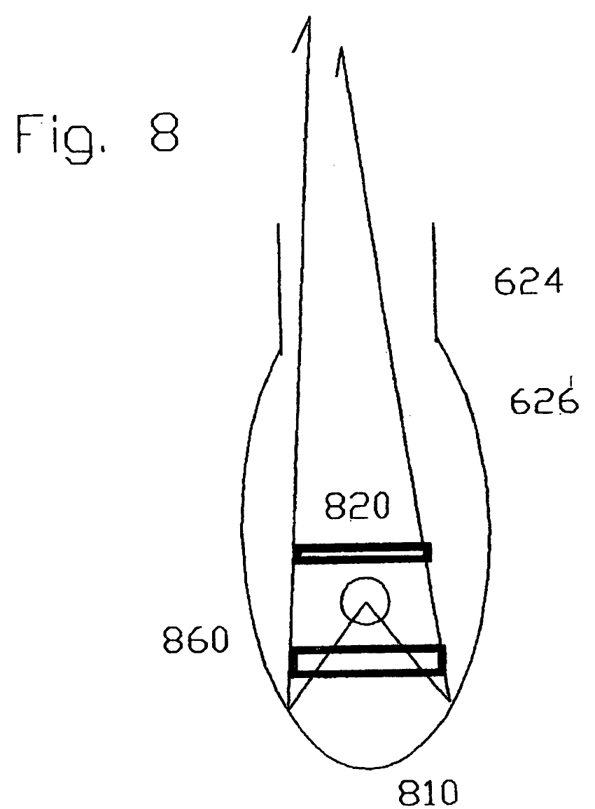

FIG. 8 presents a top view of a cross section of the interior of the rotating cylinder 622 of FIG. 6. The rotating cylinder 622 is constructed with an interior reflective inner cavity 810 which directs the output of stationary LEE 820 to the exit port 624. The output of LEE 820 in a simple construction may be broadly circumferential or focused to transverse optical lens element 860. Lens element 860 may be fixed or variable to direct and focus the output of LEE 820.

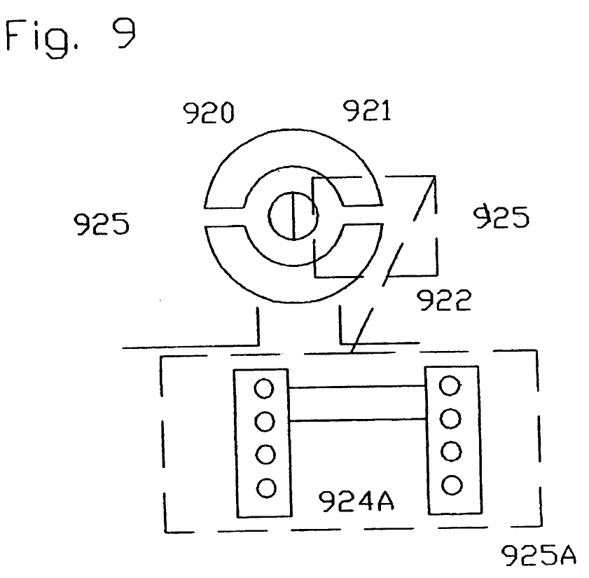

FIG. 9 present a top view of a cross section of the rotating cylinder of an embodiment of the present invention employing multiple LEE arrays. Rotating cylinder 922 shows two exit ports 924 and 925 and two opposite facing LEE arrays 920 and 921. In multiple port operation, the successive frames to one stereo view may be first presented by one port and then by the other. Thus, a full view is updated twice in one revolution of the cylinder. Alternatively, the exit port may contain apertures 924a with intervening dark spaces which correspond to the apertures of the opposite exit port 925a. This permits interlaced images from the same LEE array.

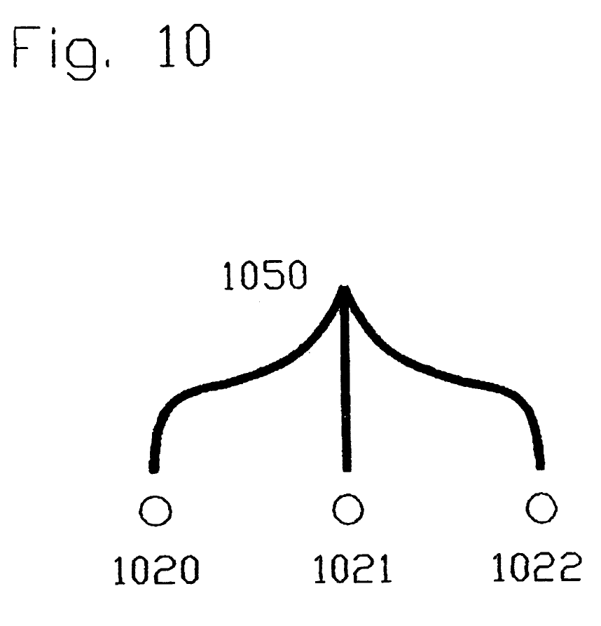

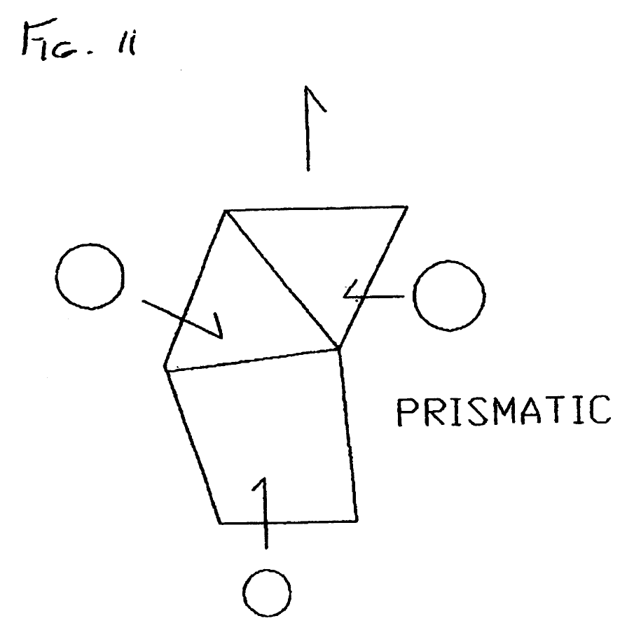

FIG. 10. presents a waveguide method of combining three primary or other colored LEE 1020, 1021, 1022 into an optical waveguide 1050 to produce a full color image.

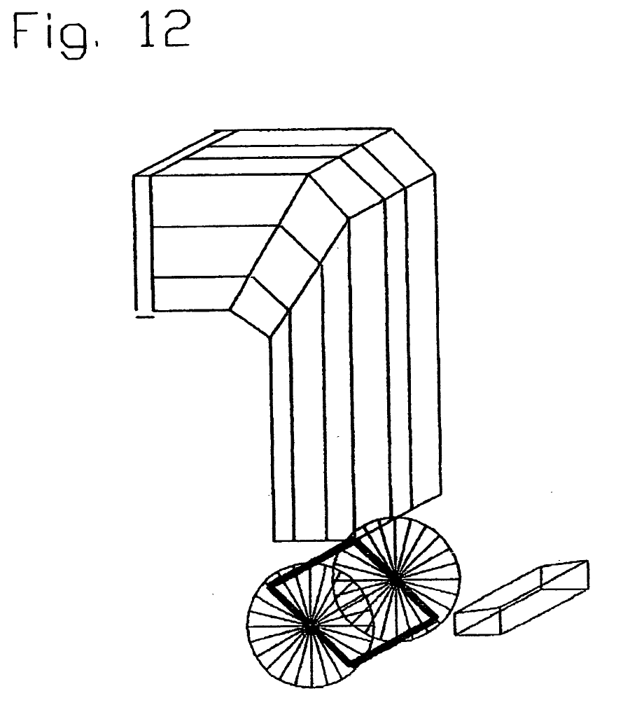

FIG. 11 presents a prismatic method of combining three primary or other colored LES 1020, 1021, 1022 into a series of prisms 1150 to produce a full color image. Similar systems are employed by television and other cameras and projectors.

FIG. 12 presents the scanner/encoder method for a waveguide type screen display. This system may be employed for stereoviewers in the form of goggles, screens, or projections.

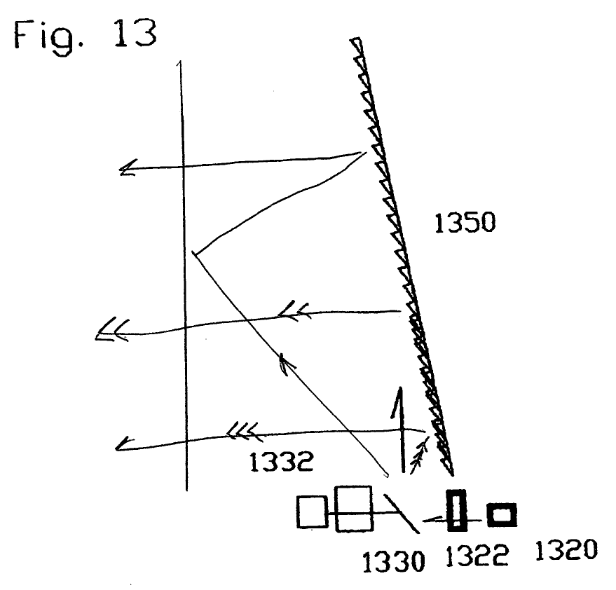

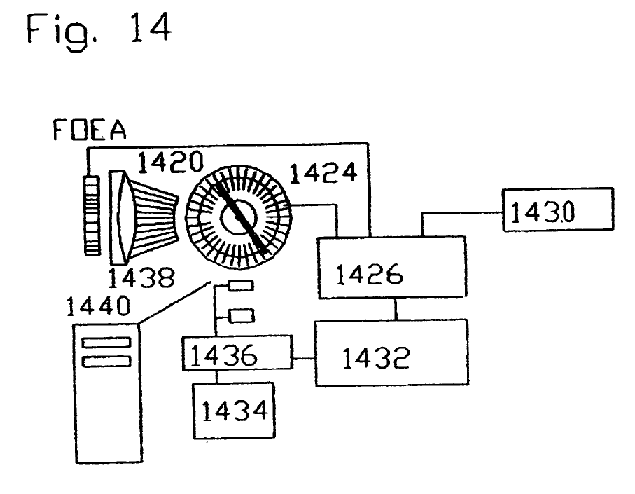

FIG. 13 presents a cross section of the translocation reflector method with a lenticular type screen. The components are an LEE array 1320, a FOE array 1360, a translocation reflector 1322, an actuator 1330, a counterweight 1332 and an position encoder 1340 and a screen 1350. In operation, a section of the full view is presented on the LEE 1320, focused by the FOE array 1360, reflected by the translocation reflector 1322 and the screen 1350. The screen may be of a fresnel, lenticular, stepped or holographic construction such as to present a focused image of the LEE 1320 to a viewer. A circular polarizing window 1360 may be placed between the observer and the screen to extinct external ambient light.

FIG. 14. presents a block diagram of the fundamental relationships between the components in the present invention. In operation, the position of reflector 1420 is monitored by encoder 1424 which sends a signal to computer 1426 updating the frame register and frame buffer address 1432 to the full image buffer memory 1434. The data output is fed up driver circuitry 1430 for the LEE array 1438. Interfaced to the computer 1426 is the TIM 1440. The computer may have an external link 1430 to devices including cable transmission, data storage, workstations, VCR, etc.

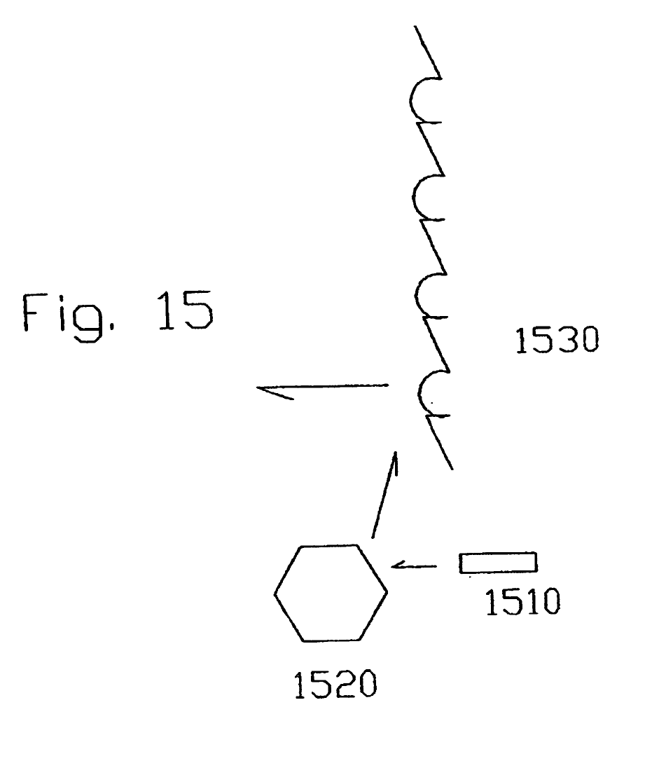

FIG. 15 presents a rotating polygon embodiment of the present invention. The system projects an image of the LEE 1510 by scanning a rotating reflective polygon 1520 and projecting the image onto a viewing screen or reflective micro-optic surface 1530 viewed by the observer 1540. A circular polarizing aperture 1550 may be placed between the screen 1530 and the observer 1540 and the LEE 1510 output modulated to produce a range of elliptical polarization whereby the external ambient light is extincted while the image of LEE remains visible. The LEE 1510 modulation may be used to control color and intensity as well. The LEE 1510 although shown as a single row may be constructed of multiple rows thereby projecting either a ID array of elements optically-combined for increased brightness or intensity modulation, or a 2D array. As a 2D array with appropriate spacing between elements, the optical deflection angle may be reduced to the spacing arc. This technique in combination may be used for large stereoscopic, autostereoscopic and monoscopic projection systems.

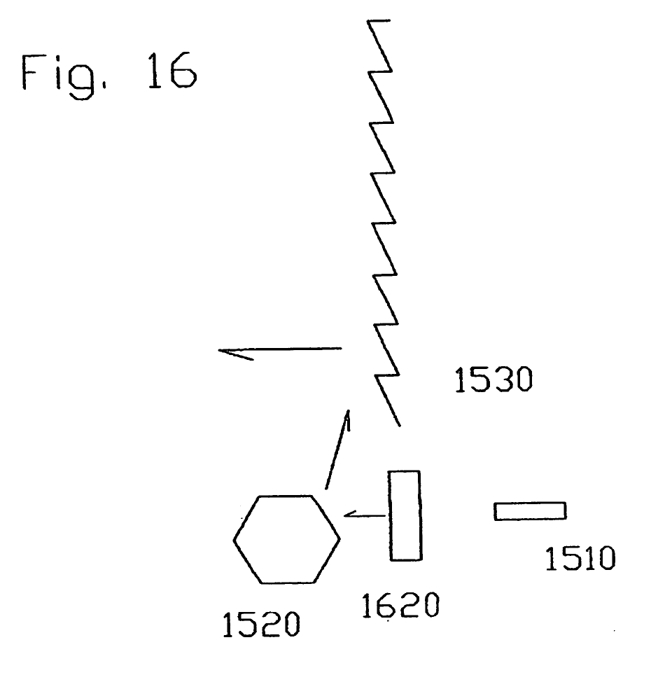

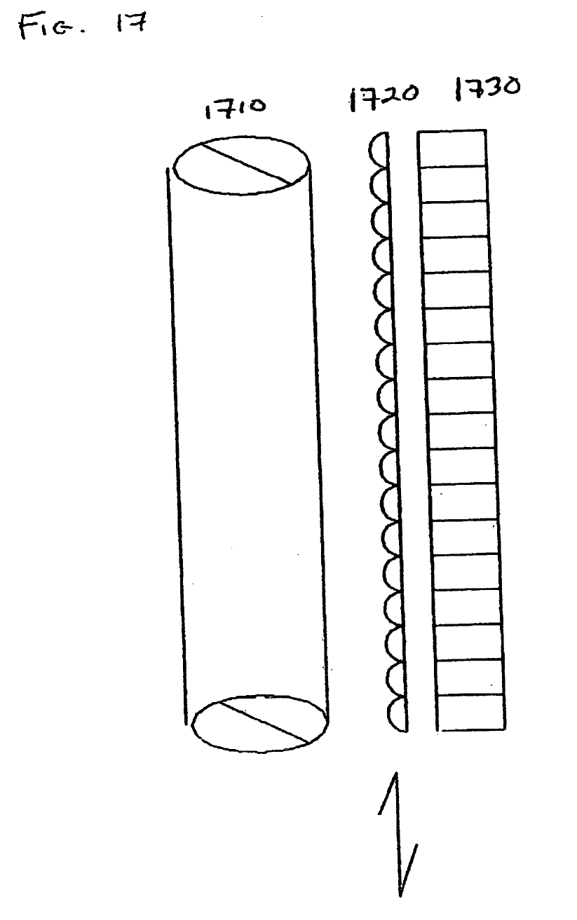

FIG. 16 presents the embodiment of FIG. 15 with an FDOE 1620. A TIM and position encoder may be employed.

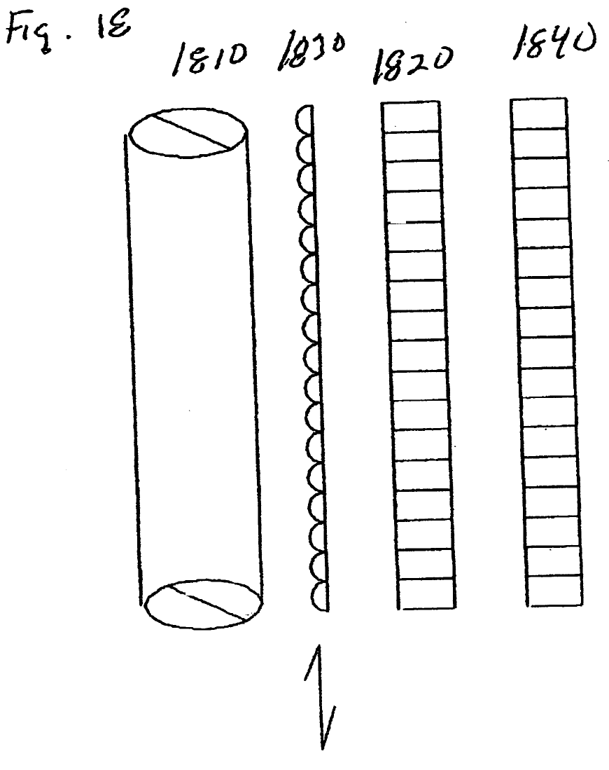

FIG. 17 presents a embodiment of the transducing interlaced mask system. In operation, the scanner 1710 scans an image of the transduced interlaced mask 1720 which is construct of a series of apertures and collecting regions of the LEE 1730. The transducing elements may be mechanical such as a piezo, voice-coil, or other displacement device or optical such as LCD, acousto-optic, SLM, diffractive or other mechanism.

FIG. 18 presents the embodiment of FIG. 17 with an FDOE 1820. A TIM and position encoder may be employed. A scanner 1810 projects the FDOE 1820 modulated image on the transduced interlaced mask 1830 of the LEE 1840.

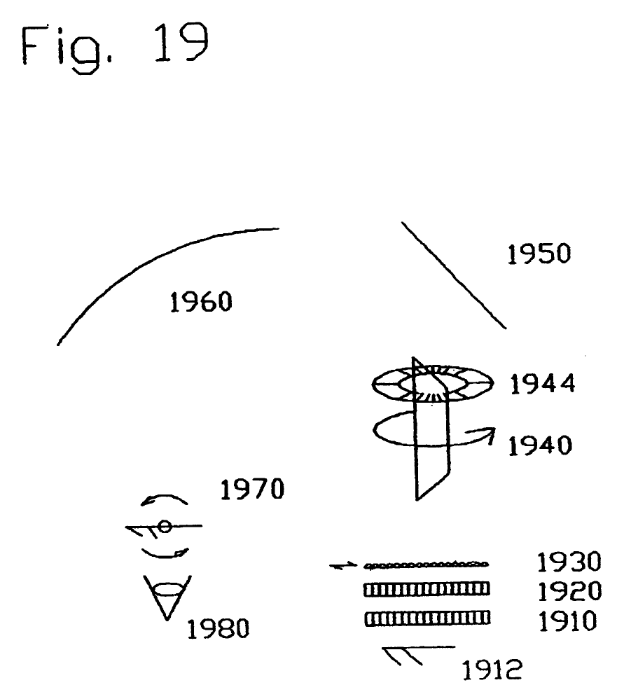

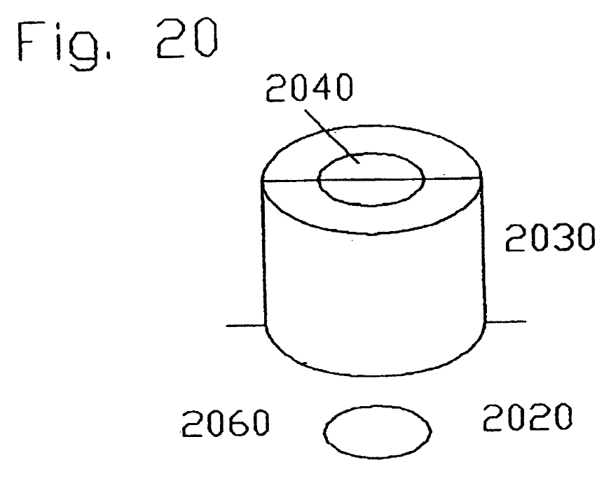

FIG. 19 presents a cross-sectional view of a prismatic embodiment of the present invention. The components are the LEE array 1910, the TIM 1920, the FDOE 1930, the Dove prism 1940, an position encoder 1944, a first reflector 1950, and a second reflector 1960. The viewer's eye is represented by the icon 1980. In operation, the image of the LEE array 1910 is projected through the Dove prism 1940 and the other optical components to the viewer's eye 1980. As the Dove prism is rotated orthogonally 1942 to the LEE beam, the linear image 1970 of the LEE is rotated a twice the rate. The result is a circular image of the linear array. As each increment angular displacement, the position encoder signals the projection of the corresponding linear section of the full view. Multiple LES, set radially, may be employed to reduce the necessary rate of rotation or increase the resolution. The TIM 1920 and FDOE 1930 may be integrated into the image. Reflector 1950 may be a beam splitter sending similar images to both eyes. Other optical paths including a direct view without reflectors 1950 and 1960 may be used. Dual coordinated systems may be employed for stereo viewing.

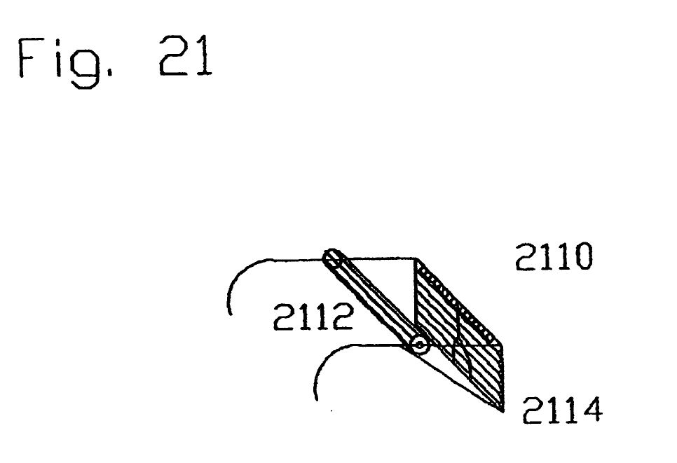

FIG. 20 presents a perspective view of one embodiment of a single element of the focal distance optical element. The components are the LEE 2020, a piezoelectric cylinder 2030 and a variable optical element 2040. In operation, an electrical charge applied to the piezoelectric cylinder 2030 varies the compression of the enclosed optical material 2040 resulting in a change in the focal length of the optical element. To a viewer, the LEE will appear to vary in distance when the eye adjusts to the minimum focus. This approach requires a dark region 2060 adjacent to the focusable element for single elements, or an image edge. Focal length adjustment may also be effected by electrostatic reflective membrane arrays, gradient index liquid crystal arrays, SLMs, diffractive elements, multiple internal reflections and other known technologies.

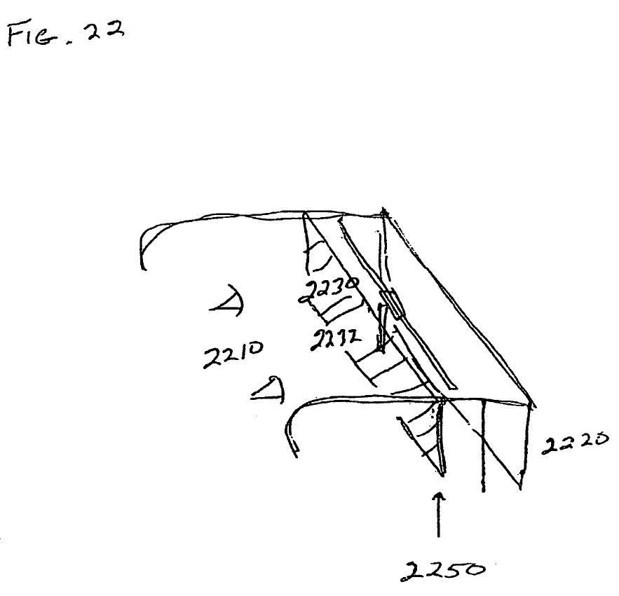

FIG. 21 presents a perspective view of rotating reflector 2120 goggle structure with LEE arrays 2110 and a lenticular reflector screen 2130. Optional FDOE, TIM, and electronic interconnections are omitted from the diagram.

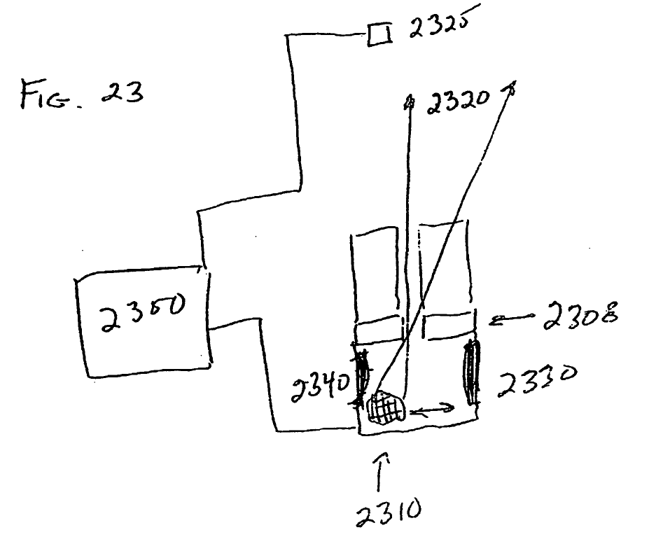

FIG. 22 presents a scanning stereo viewer using micro optic domains with a polarizing aperture. Similar to the embodiment of FIG. 21, an image is projected onto a screen 2220 from scanner 2230 or 2232 and viewed by observer 2210. A transparent polarizer window 2250 is interposed between the observer 2250 and the screen 2220. The screen may be constructed of reflective micro domains which focus the image to one observer or disperse the image for multiple observer. The beams of light from the scanner 2230 are either unpolarized or the polarization is modulated to control intensity or color.

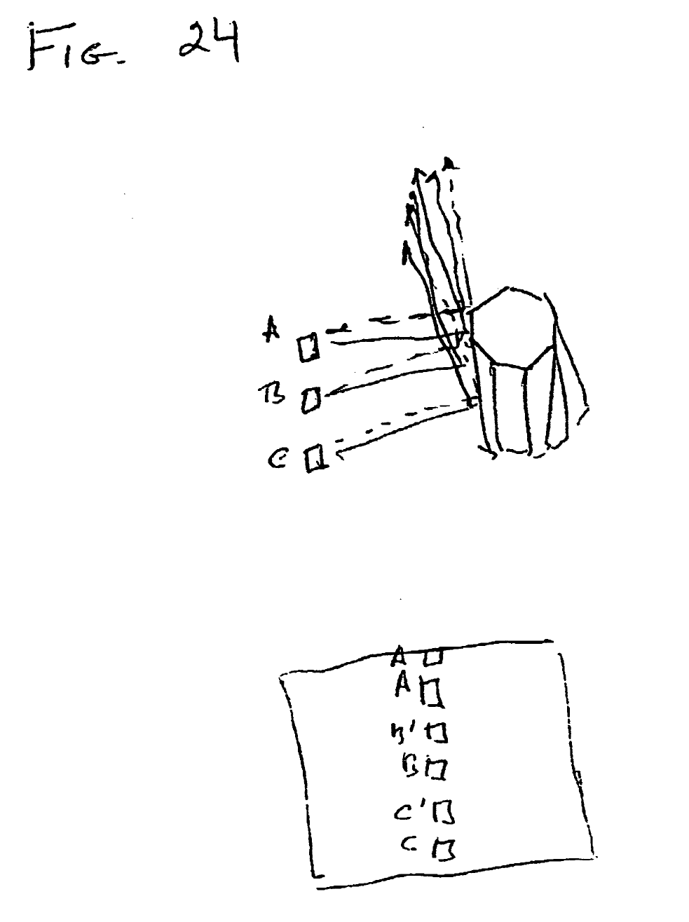

FIG. 23 presents a scanning stereo viewer using plasma cavity. The individual elements may be a one or more dimensional array and may be located on the screen or at a central focal point. In operation, for two view stereoscopy, the output from the light focusing aperture 2308 of the illuminated plasma region 2310 is in a solid cone 2320. By means of field control elements 2330, electromagnetic control elements 2340, piezo or other means, the plasma region 2310 is made to cyclically translocate, causing the output cone 2320 to sweep a designated region. An imaging computer system 2350 synchonizes the image to the sweep position. In a closed loop feedback embodiment, a CCD or other similar reference element 2325 receives a register beam controlling the modulation of the image. As a two-dimensional array, this embodiment may be used as an scalable autostereoscopy screen, mounted as a continuous array over the field of view of the observer analogous to the TV panel 120, 125 of FIG. 1. Alternatively, this embodiment may be a stand alone panel.

FIG. 24 presents an autostereoscopic embodiment of the present invention. A lenticular-type screen 2410 is used to project the scanned image of a viewer field array of LEE 2460 to a range of observers 2430, 2432. At each position in the audience, the observer will see a distinct image with each eye. In FIG. 24, the lenticular array is used to provide vertical dispersion. The screen may be bidirectional and impart horizontal parallax as well when coupled with a singe view horizontally scanned LEE array. In operation, the scanning mechanism may be closed loop coupled to an encoder 2442 whose registration is proximal or distal in the form of receiving arrays 2444 near the screen or 2446 at the audience. A transparent circular polarizing window 2420 may be placed between the observer 2430 and the screen 2410 to extinct ambient light. It may be understood that the aperture array 2450 and multiple view LEE array 2460 may be consolidated into a single view LEE array and a lateral beam deflection mechanism. A lateral tranducing element may be added to the aperture array 2450 to interlace a higher resolution. Another configuration utilizing a similar architecture may place the lenticular array vertically with lateral scanning and vertical viewer dispersion.

The scanning approach presented in the present invention provides a direct, inexpensive and uncomplicated method to project a visual image with 3D qualities. The image is further enhanced by using focal distance optical elements to correct a significant shortcoming of most stereoviewers. The multiple port or array approach reduces the rotational or translocation cycle rate necessary for a given resolution and facilitates high resolution displays. As an example consider a 100 LEE array with 8 positions per cycle, 1000 cycles per frame at 30 Hz and a displacement cycle rate of 240 KHz The duration of single element is 2.5 microseconds per cycle, or 75 microseconds per second. Maximum resolution requires unfilled space between image elements.

The position encoder replaces the need for a precise control of the rotational or translocation system. This is important in coordinating stereo systems. Further, absolute registration of a frame relative to a person's view is important in stereo systems to insure proper stereoscopy and precise positioning of the head-eye-object orientation in virtual reality or vertically systems.

The features and methods presented herein may also be used to produce a useful monocular, screen or projection display.

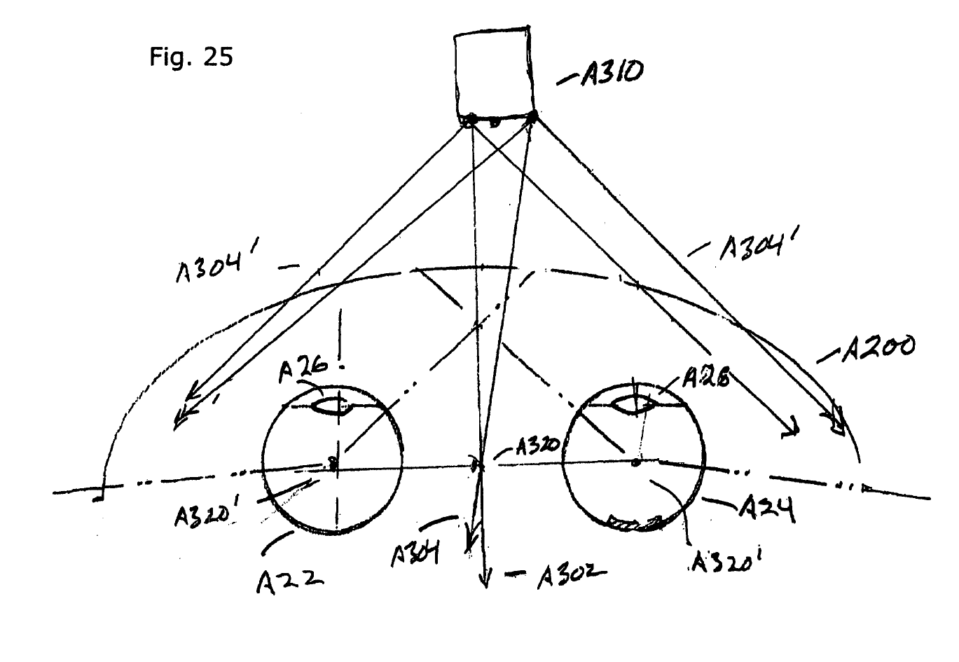

FIG. 25 shows a top view of the virtual image in a head mounted display embodiment of the present invention where the virtual beams A302, A304 representing the object A310 are shown intersecting the screen A200 at the approximately location and angle required to replicate the beam pattern which would exist in real space. Thus the position of the observer's eyes within the constraints of the display A10 are irrelevant to accurate perceive an image. The optics required to produce this beam pattern are not straightforward and may be achieved with a constant, discountinuous, flat wavefront. The principal image beam convergence point A320 behind that of the lens of the eye A26, A28 preserves the relationship independent of the eyes A22, 24 relative position to the screen A200. Alternatively, two eye-related convergence points A320′ may be established.

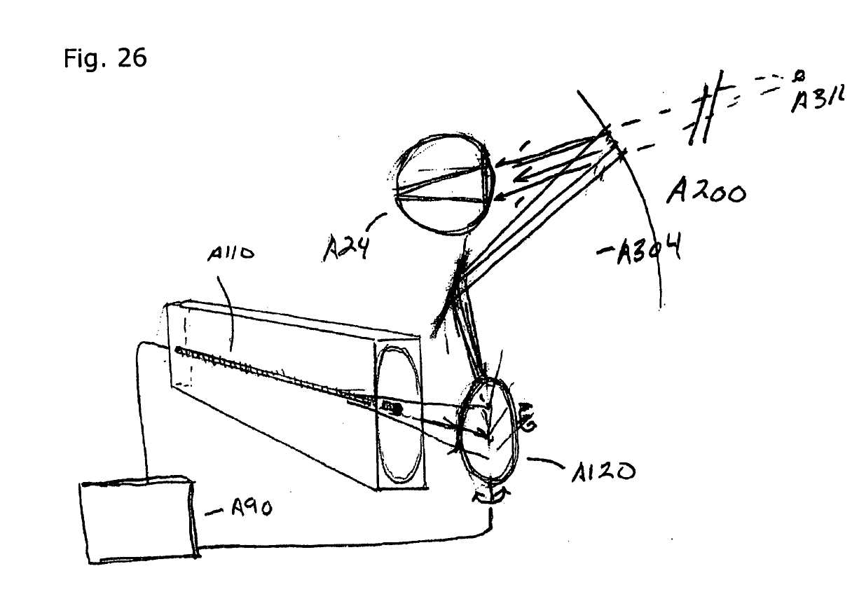

FIG. 26 shows a perspective view of the linear array, continuous focal distance embodiment of the present invention where the component parts of the light source and scanning assembly A100 are shown including a image computer A90, a linear array of light sources A110, and a two axis, scanning mirror A120. In operation, the computer A90 communicates with the scanning mirror A120 through an open loop drive system, closed loop position feedback or other known positioning system and illuminates those light sources A110 which correspond to the image points A310 to be displayed. The divergent beams from each light sources A110 may be focused by the eye A24 to correspond to the appropriate object distance.

While the linear array of light sources A100 is shown as an array of light emitters such as LEDs (light emitting diodes) which are driven by an image computer A90 through circuits not shown, alternative light sources may be employed. Examples of such alternatives include electronically, optically or mechanically activated emitters, shutters, reflectors, and beam modulators. Specifically an FLCD shutter array as shown in Fig., a fluorescent or two-photon emitter as described by Elizabeth Dowling, or a mechanically reflector such as Texas Instruments DMD device may be used.

In all optical systems the axial image or zero-order view may be block and the image formed from the divergent beams from the emitter.

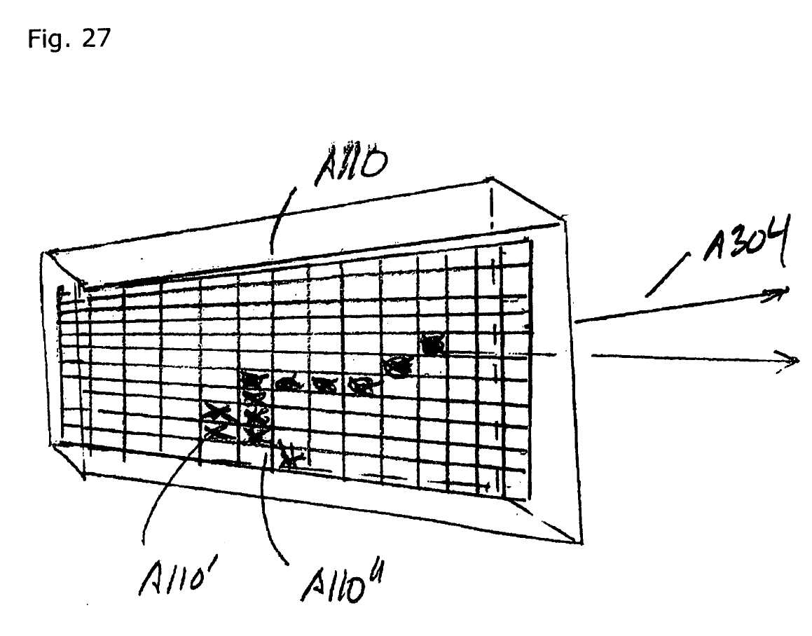

FIG. 27 shows a perspective view of the 2D planar array, continuous focal distance embodiment of the present invention where a two dimensional matrix of light sources A110, A110′ which produce the image beams A304. Although a multiplicity of 2D arrays A110 may be used to produce a 3D matrix full display, a preferred embodiment combines the 2D array with a scanning mechanism A120 to create the full image.

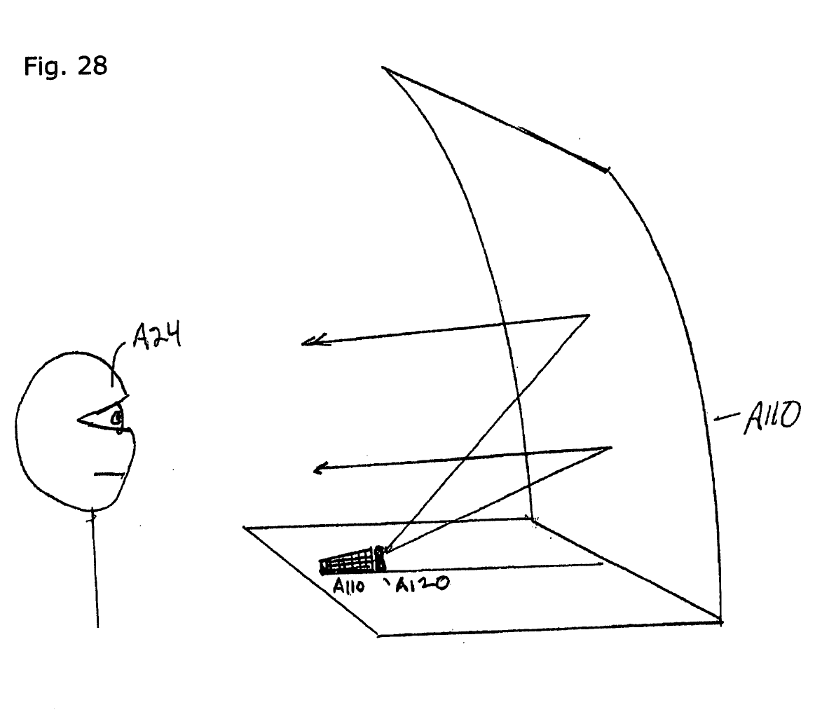

FIG. 28 shows a side view of the planar array, continuous focal distance embodiment of the present invention applied to an autostereoscopic display where the light source A110 and scanning assembly A120 project the beams towards the screen A200 and then to the observer's eye A24. It may be understood that the scanning assembly A120, projection optics and screen A200 may include embodiments of my previously filed and co-pending patent applications for autostereoscopic displays, thereby incorporating the present invention in the function of the light source and focal distance control.

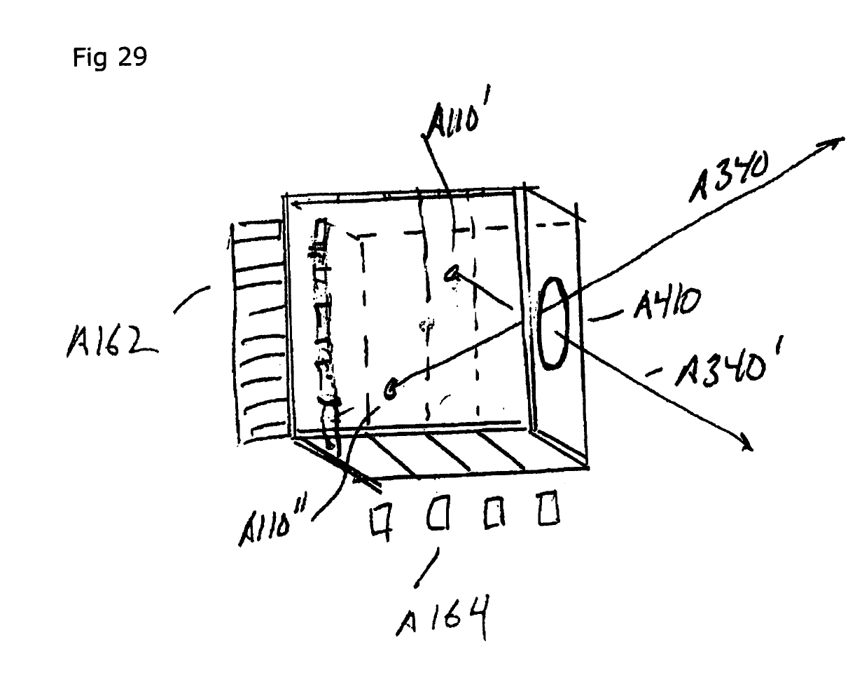

FIG. 29 shows a perspective view of a two-photon activation embodiment of the present invention. Over the past fifty years, researchers have developed a number of techniques for the photo-activation of light emitters. In recent years, Elizabeth Dowling of Stanford University has perfected a technique using a two-photon activation method. This approach may be useful employed as a light emitter in the present invention.

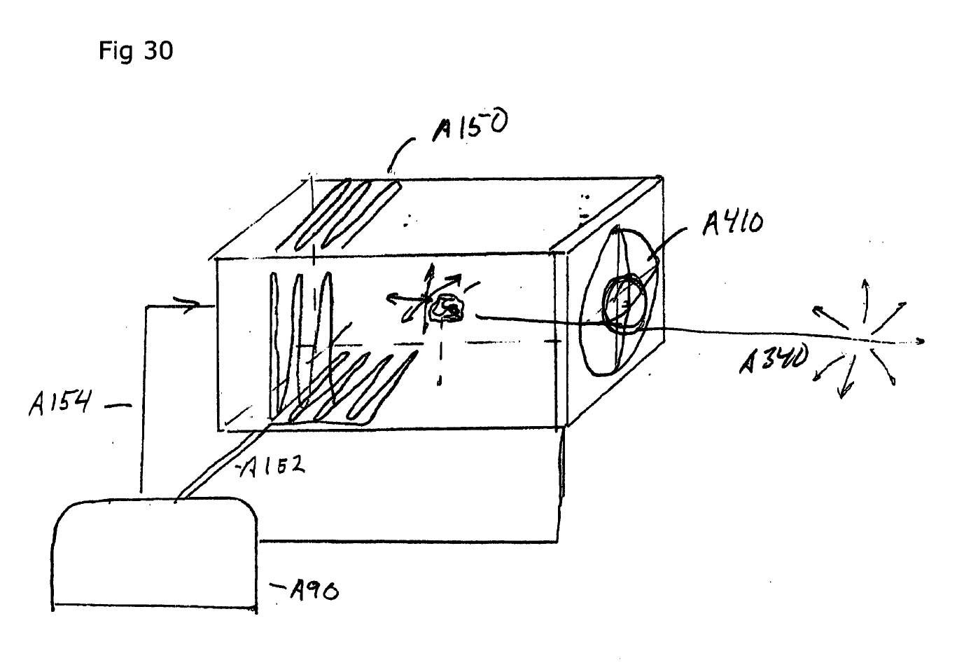

FIG. 30 shows a perspective view of a plasma or floating emitter activation embodiment of the present invention where a light emitting region where a defined light emitter region A 10 is displaced in space and activated under the control of the image computer a90, the displacement field control structures A150 and the activation signal A154. The output beam A340 is structured by output optics A410.

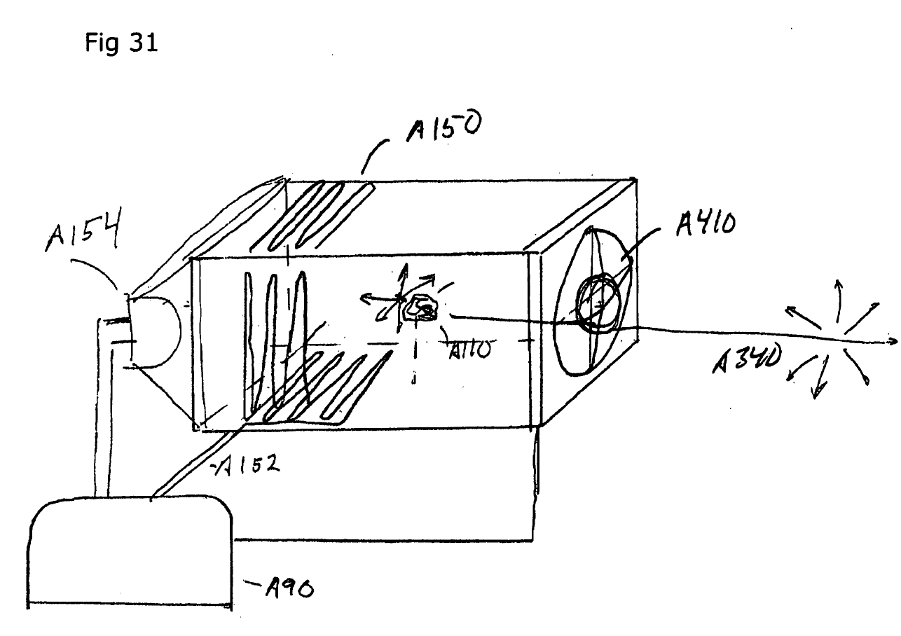

FIG. 31 shows a perspective view of the reflector or optically activated emitter activation embodiment of the present invention where a light emitting region where a defined light emitter region A 10 is displaced in space and activated under the control of the image computer a90, the displacement field control structures A150 and the activation signal Al 54. The output beam A340 is structured by output optics A410.

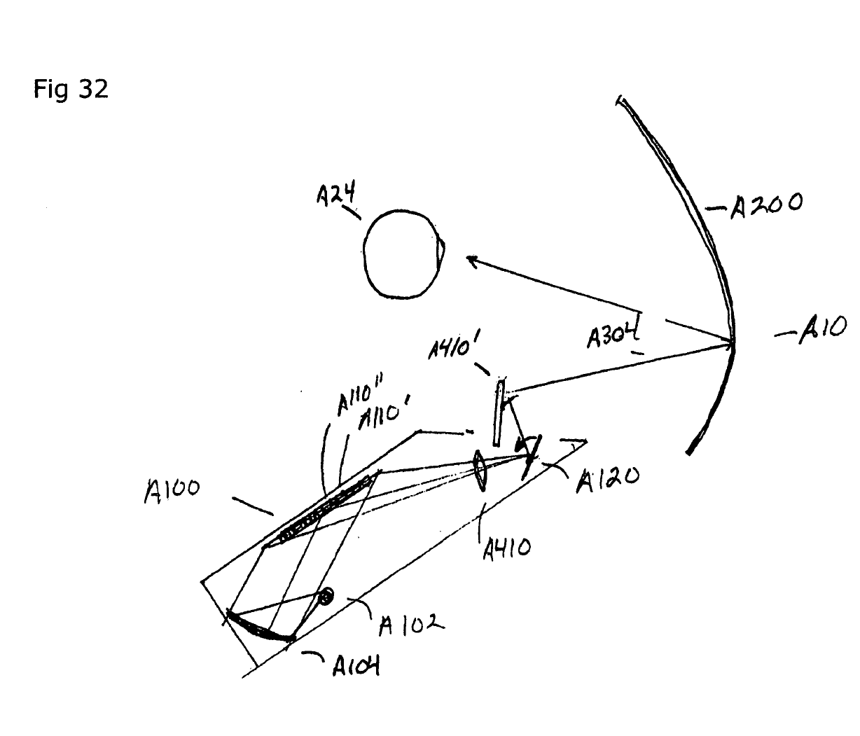

FIG. 32 shows a side view of the angled reflective planar array, continuous focal distance embodiment of the present invention where the light source A110 and scanning assembly A120 projects the beam towards the screen A200 and then to the observer's eye A24. Specifically, a light source A102 and reflector A104 illuminate an array A110, A110′, A110″ shown as a section of a planar array which provides depth function for a multiplicity of image pixels. A ray A304 from the appropriate pixel A110 corresponding the depth function of the pixel is reflected to the imaging optics A410, the scanning optics A120 shown as a rotating mirror, and a reflective HOE optical element A410′ which imparts the angular divergence required to present the proper cone of rays to the HOE augmented reality screen A200 and then to the observer's eye A24.

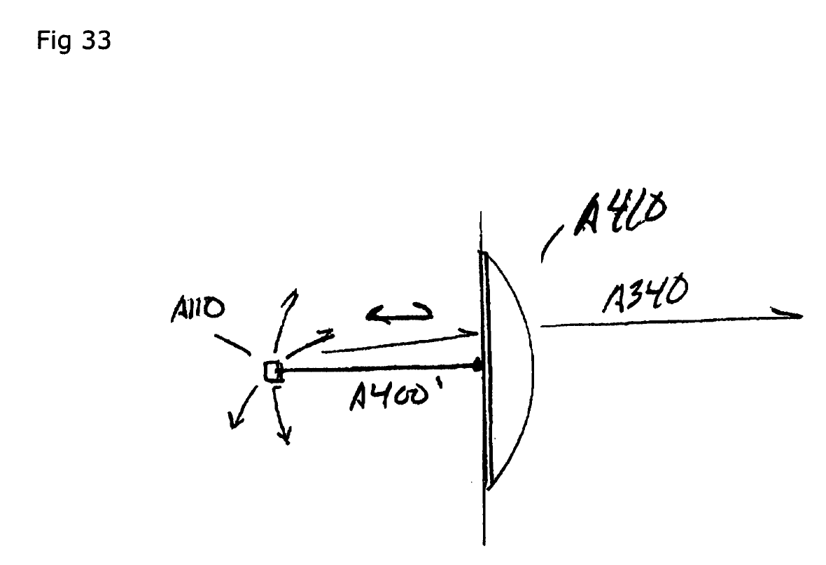

FIG. 33 shows a side view of an improved aberration free light source and scanning assembly A10 where a light source A110 is scanned affixed to a movable member A400 affixed to a point on the plane of the projection optics A410 and the output beam is emitter about a path diverging generally along the movable member A400.

The light source A110 and movable member A400 may be chemically, electrodynamically, mechanically (physical, piezo, acousto), or optically displaced in a resonant or pixel determined fashion. Multiple light sources A110 may be affixed to the movable member A400 with intervening non emitting regions thus reducing the required displacement required. The movable member may be cyclically or predeterminably lengthen and shorten to impart a variable focal length. A multiplicity of movable members may be employed. The electronic circuits, which may be formed from transparent conductive films, are not shown. This approach may be used in low cost consumer and toy applications.

The present invention optimizes the current performance/cost parameters of commercially available processes. Contemporary, medium cost, high-speed, light sources, either emitters or shutters, together with associated electronics have digital modulation frequencies in the range of 10-100 MHz. A full field display should have at least 2000.times.1000 pixels of resolution (2 megapixels) and a refresh rate of 72 Hz. The resultant data rate for a single plane, single emitter light source is 144 MHz. When 24 bit color depth is added, a digital modulation frequency must be increased by at least a factor of 8. Adding focal depth of 10,000 points, a modulation frequency of over 10 terahertz is required. Thus is it apparent that a simpler, more cost effective approach is an increase in the number of light sources. The present invention provides a direct solution to this problem. Section Two

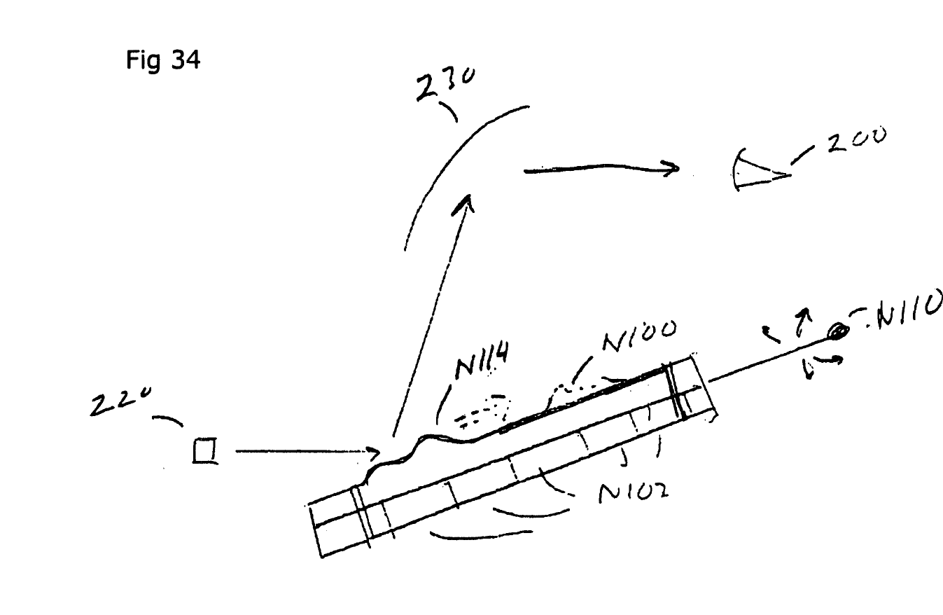

FIG. 34—Multiple Axis—presents a perspective view of a preferred embodiment of the present invention wherein the deformable membrane incorporates a pattern permitting an increased range of the redirection of the incident radiation. The structure is comprised of a deformable membrane N100 suspended above or between one or more programmable electrodes N102, which may be transparent. In one configuration, the incident beam N104 is reflected from the membrane N100 towards the visor mirror 230 and observer's eye 200. In operation, the control electronics N110 applies a variable charge to electrodes N102 causing a localized deformation N114 of membrane N100. The amplitude and timing of the applied charge may cause the localized deformation N114 to travel about membrane N100 in a vector or raster pattern. the deformation of membrane N100 is synchronized with the modulation of LEE 220 causing a specific image pixel to be illuminated. The pattern may simultanously control the spatial distribution and the wavefront of the beam, creating the impression of a variable focal distance with spectral and 3.sup.rd and 5.sup.th order optical aberrations corrected. The membrance N100 and structure may be mounted upon a translocatable, movable or resonant structure to further enhance its range and applications.

The membrane may be lateral or other incisions/discontinuities for a linear translocation.

Heterogeneous chemical and mechanical domains in the membrane may be included and individually activated by photonic, mechanical, magnetic or electronic means.

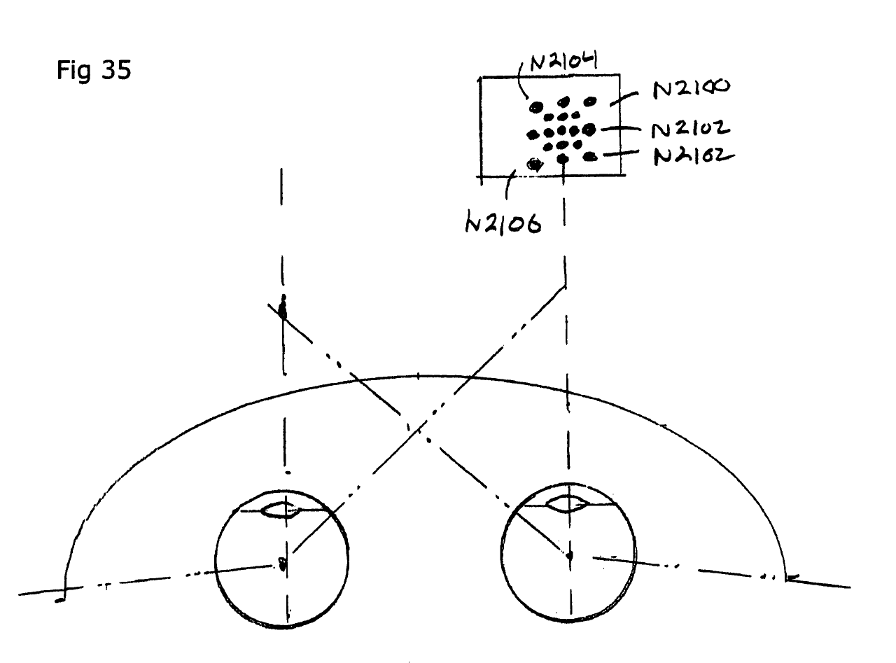

FIG. 35—Interneural Motion Processing—presents a preferred embodiment of pixel pattern N2100 containing multiple pixels N2102 which are illuminated simultaneously or with discrete precalucated intervals. While the human retinal captures photons in microseconds, processing by the retinal neural system imparts a time course which acts to enhance or inhibit adjacent biological vision pathways. A single scanned photon may when illuminated at a certain frequency induce the cognitive visual impression of motion in the opposite direction. At a image level, this is observed in the spoked wagon wheels of older Western films. At the biological level, the result may be confusing and ambigous, thereby substantially reducing a fighter pilots response time, for example.

Many image processing systems compute the next image well in advance of the 72 hertz visual refresh rate and may extrapolate images to include the intensification of certain pixels N2104 or the reduction of other pixels N2106. When correlated to visual field speed, this enhances the observers response. Reference: USAF Advanced Flight Cockpit Study, MIT, 1997.

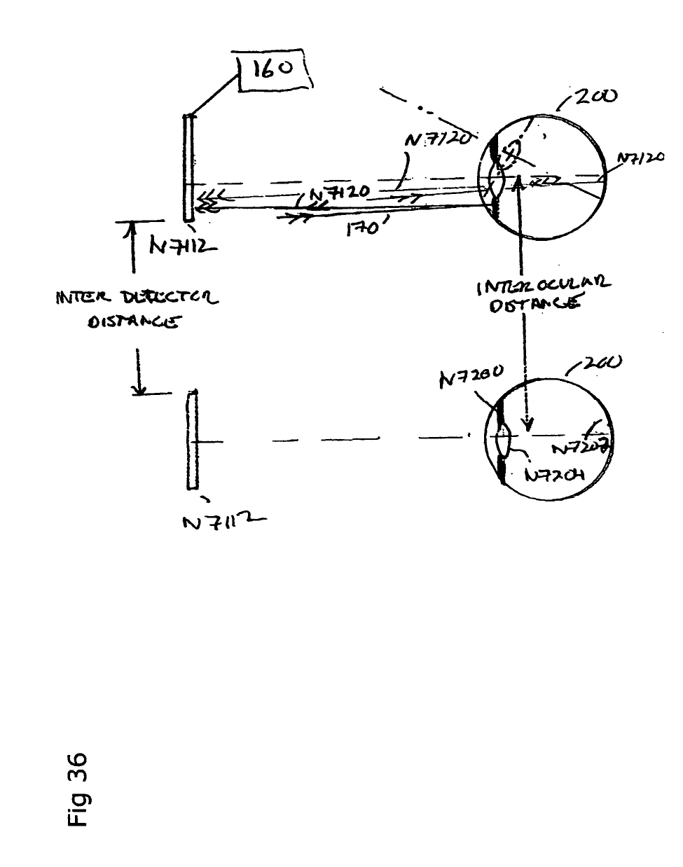

FIG. 36—Interocular and Retinal Distance, Shape and Range of Movement—presents a preferred embodiment incorporating the dynamic interocular distance and orientation control. One method of alignment and orientation of immersive displays employs one or more test patterns which provide the observer an alignment or adjustment reference. Standard tests for image position, focal distance and stereo alignment may be incorporated in manner similar to adjusting a pair of binoculars or stereomicroscope. Additional tests which incorporate dynamic motion and require hand-eye coordination may be included.

In the present invention, two complementary improvements are employed which permit dynamic adjustment. The first part measures the range of eye motion of each eye by recording the limited of the iris movement. The second parts the range of retinal image focus and position by projecting a visible or invisible test image and recording the dynamic changes of eye position and focus.

This is accomplished by monitoring the eye state by means of a reflected beam N7120 and a reflected image detector N7112 which may range from a single photodiode to a full color hi-speed camera. An incident beam 170 which may be visible or invisible is reflected from the iris N7200, the retinal N7202, or the eye lens N7204. Spectrographic analysis may be used to identify the source of the reflected beam.

The control computer 160 receives the data from the image detector N7112 and other external systems including the interocular distance which is either fixed or includes a known measuring detector (not shown). This provides sufficient information for the calculation of the orthogonal visual axis of the immersive display relative to the observer and permits an adjustment of the display image including apparent focal distance, stereo image disparity, and visual axis orientation.

This dynamic adjustment may be useful convenience for all users and of crucial importance to fighter pilots and other environments where high stresses may cause a physical displacement or distortion of the display or body morphology. An test example for dynamic control would measure the retinal shape and curvature by monitoring the focus of a scanned point in a single photodiode detector system or the width and curvature of a line with a two dimensional detector array. Dynamic monitoring of retina would correct for G forces and other anomalies during high speed turns by fighter pilots and astronauts.

Additional external eye state systems such as are manufacturered by ISCAN, Inc. may be employed and the data integrated by the control computer 160.

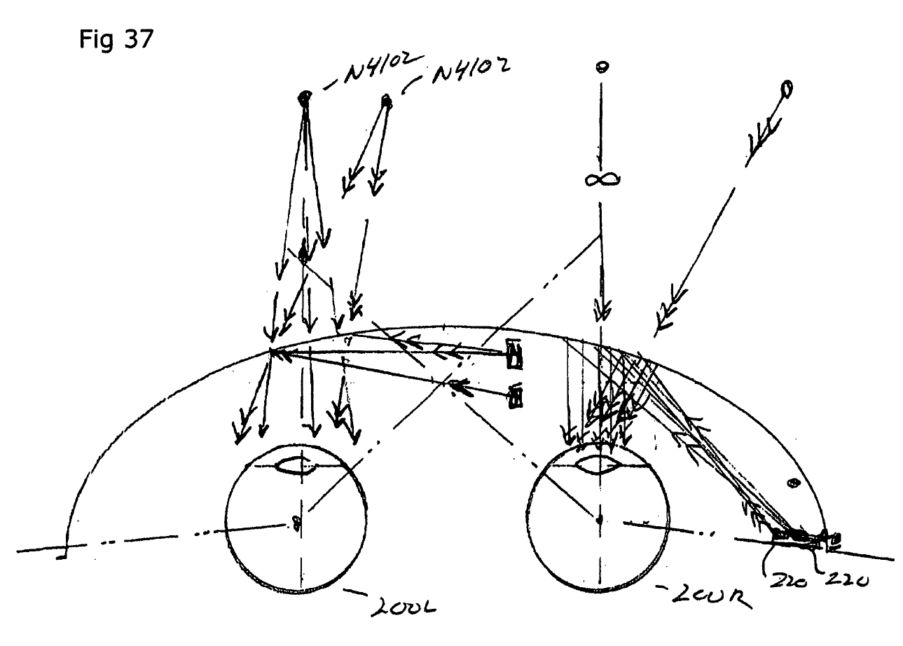

FIG. 37—Distant Focus—presents a preferred embodiment wherein a fixed focus length is set by multiple horizontal elements which are vertically scanned. Other orientations may be employed. Alternatively as shown in FIG. 4A, one or more emitters 220 may be used in a scanning system. In this FIG. 4 emitter may include the other optical emitter group components including variable focal length. The left eye 200L observes a virtual image at point N4102. The right eye 200R observes a image set at infinity. While the relative position of point N4102 in relation to the left eye 200L is important, it is less so in the infinite focal length example. With all image points being compressed into the infinite plane, image object occlusion disappears. A object only viewed through an aperture would still be subject to minor occlusion at a global scale

The variable focal length faculty of the present invention may be exploited to permiit global or sectional virtual screen at a fixed focal length—with or without correct stereoscopic image disparity. This technique may be used for medical and performance diagnostic, data compression and reduction as well as all other purposes. A virtual screen set beyond the normal accommodative limits of the human eye (approximately 400 meters through infinity) may be minimize the impact of incorrect stereoscopic inter-ocular alignment. Under these circumstances, the projected cone of rays emanating from each pixel need not illuminated the entire pupil travel domain but may subtend the solid angle from the general region of the image object.

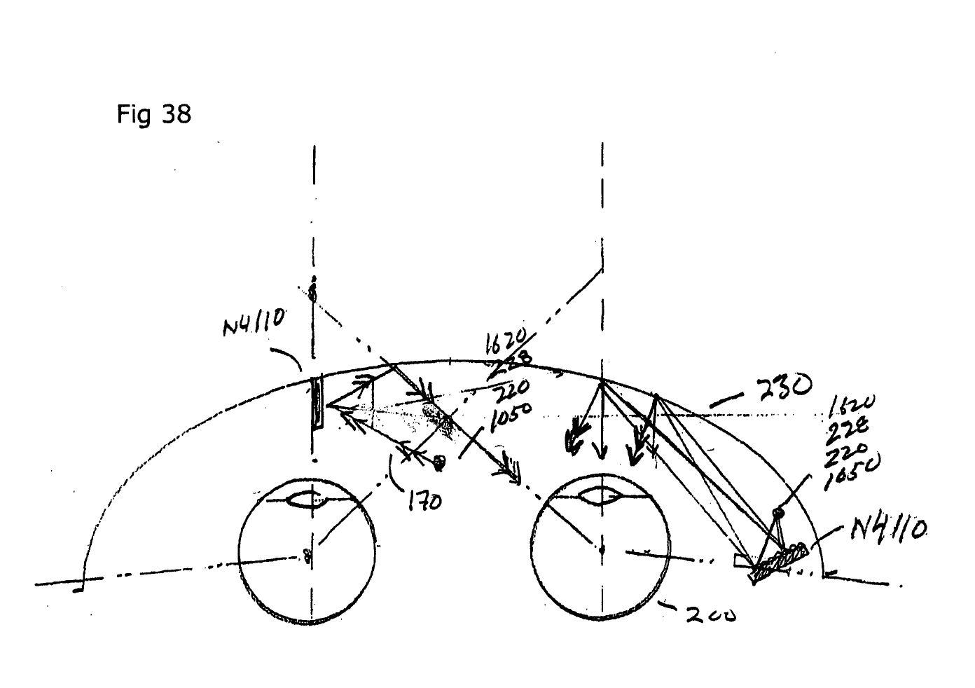

FIG. 38 shows a representative example where an intermediate transfer reflector (or transmitter) N4110 is employed. The beam 170 exits the optional focal length control 1620 if employed and is reflected (or transmitted) by intermediate transfer reflector (transmitter) N4010 towards the visor reflector 230 and to the observer 200. The reflectors may be positioned in any location or combination including but not limited to above and below the eye plane, across the field of vision, at the periphery or the center.

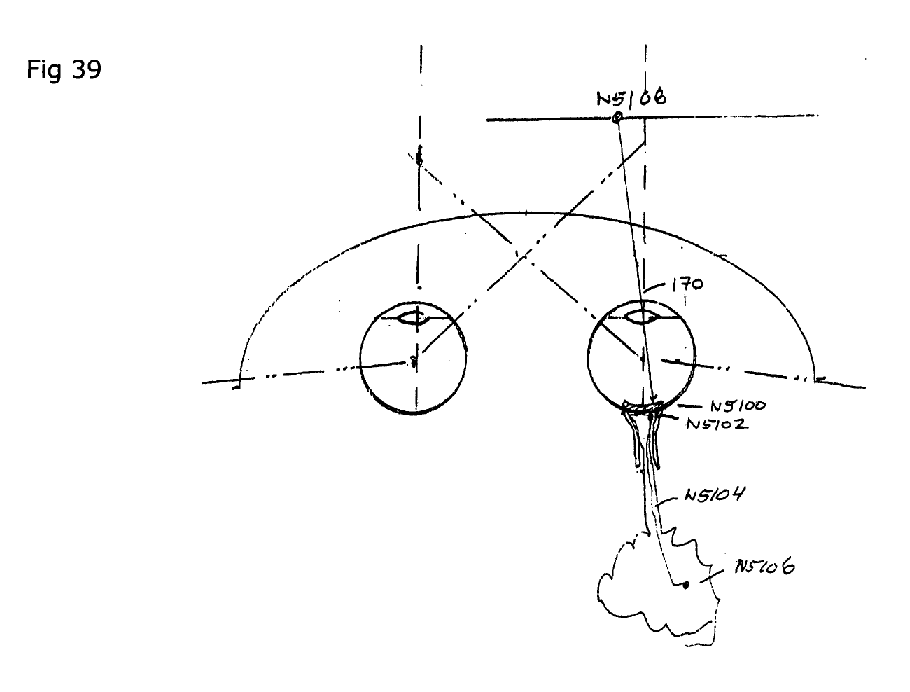

FIG. 39—Induction of Vision—The use of photonic induction of nerve transmission has been disclosed by the author in previous U.S. patent applications and papers. The preferred embodiment of the present invention discloses a method and apparatus for the direct photonic enervation of the human visual system.

It has been shown (Salzburg, 1979, this inventor and others) that the state of a neuron may be monitored optically. The reverse process is also true. The preferred embodiment incorporates the disclosed optical system in a novel way. A retinal implant N5100 receives the beam 170 which causes a localized nerve depolarization N5102 sending a signal N5104 to a brain image location N5106. The user may then identify the location in the viewer's reference (imaginary) which may or may not correspond to the virtual spatial source of the beam N5108.

The difference is received and computed by the processing computer 160 to generate a viewer's lookup table which permits a mosaic image to provide a correct view for the individual viewer's cognitive vision.

The retinal implant N5100 is the subject on the inventor's previous and pending applications and papers. The process may be used on sense, motor and aural nerves as well where processing computer 160 receives the instructions from the users biological process (Solomon, 1979) or other control systems and generates a mosaic image to activate the implant N5100.

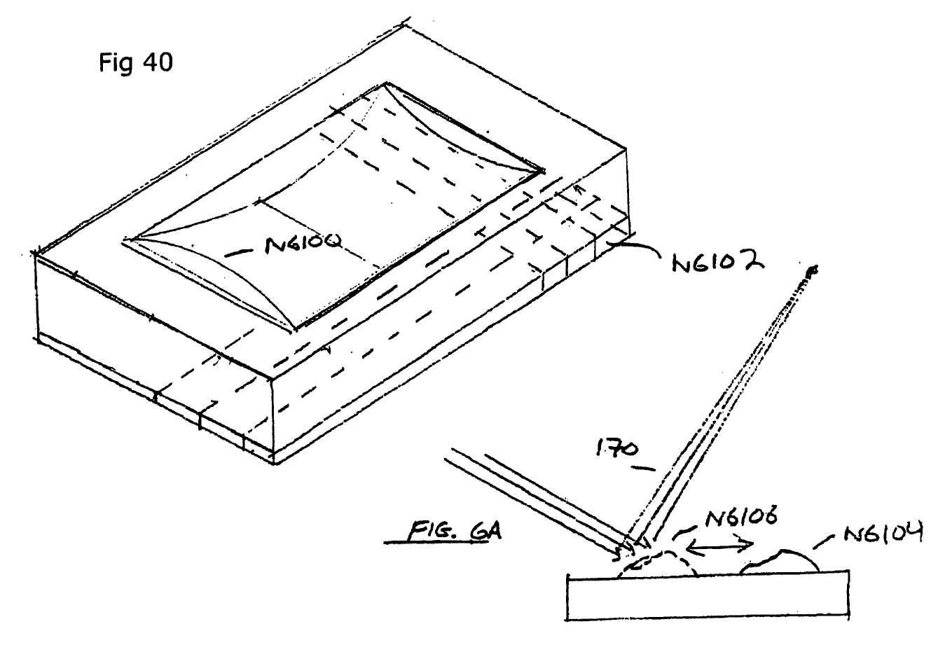

FIG. 40—Variable Membrane Tension—The use of variable shape reflective and transmissive materials such as reflective membranes, transmissive liquid lenses, and materials wherein a localized change in refractive index is induced for beam forming and scanning are well known. In a preferred embodiment of the present invention these materials are utilized to vary the focal length and beam direction in a novel construction, using both integrated and multiple elements.

In FIG. 40, an elongated concave membrane N6100 with multiple electrodes N6102 is shown. The membrane N6100 is shown connected at the corners but any configuration may used. The membrane may be in tension flat or designed with a distinct neutral shape.

FIG. N6a shows the operation wherein a shaped portion N6104 of a convex membrane N6100 oscillates between alternative positions N6104 and N6106 during a view cycle of approximately 72 hertz. The beam 170 is reflected from the surface. During each cycle the membrane undergoes a multiplicity of subtle changes which reflect the integration of the field forces generated between the multiple electrodes N6102 and the membrane N6100. These changes are controlled by the processing computer 160 and incorporate the focal length and beam direction information.

It is understood that the membrane may represent the surface of deformable or refractive index variable transmissive material using transparent or reflective electrodes at surface N6102.

The use of deformable membrane mirrors as a method for controlling the beam direction, the focal length, the modulation of intensity and chromaticity and the correction of errors has been the subject of extensive research. In Applied Optics, Vol. 31, No. 20, Pg. 3987, a general equation for membrane deformation in electrostatic systems as a function of diameter and membrane tension is given. It is shown that deformation varies as the square of the pixel diameter [a] or voltage [V], and is inversely proportional to the tension [T]. In many applications were the invention is proximal to the human eye, increasing the pixel diameter or the voltage is impractical. Consequently, dynamic changes in membrane tension offer an acceptable method for variation. Variable membranes utilizing known mechanical, photonic, acoustic and magnetic deformation may be employed.

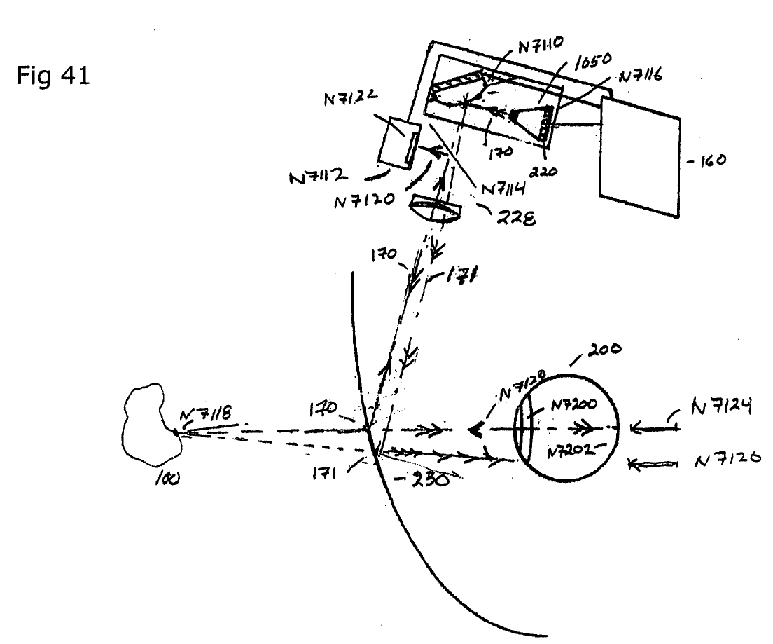

FIG. 41 shows the preferred embodiment as disclosed in related government proposals wherein the display system is comprised of a processing computer 160 which coordinates the illumination of LEEs 220, the modulation of display beam integrated translocation and focal length component N7110 and the eye state feedback component N7112. In operation, the light emitted from LEEs 220 is combined the optical waveguide 1050 and directed as a discrete beam 170 to the translocation and focal length component N7110. The beam 170 is directed and focused towards the beam splitter N7114, an optional conditioning optic 228 which may be positioned at any point between the exit aperture of the optical waveguide 1050 and the visor reflector 230, and the visor reflector 230. The beam 170 is then directed to the viewer's eye 200, presenting a replica beam of that which would have been produced by a real point N7118 on a real object 100.

Under normal illumination, a real point N7118 would generate a cone of light whose virtual representation is beams 170 and 171. The observer will perceive the object point N7118 as long image beams 170 or 171 enter the observer's iris N7200 at a viewable angle.

A reflected beam N7120 is recorded by the eye state feedback component N7112 which incorporates a detector and conditioning optic N7122 which may range from a single photodiode to a complex, hi-speed, full color camera. Data collected by the eye state component N7112 may be received and analyzed by the processing computer 160.

The preferred embodiment of the present invention may incorporate a membrane structure which dynamically and reversibly changes tension in response to applied field, charge density and photonic irradiation.

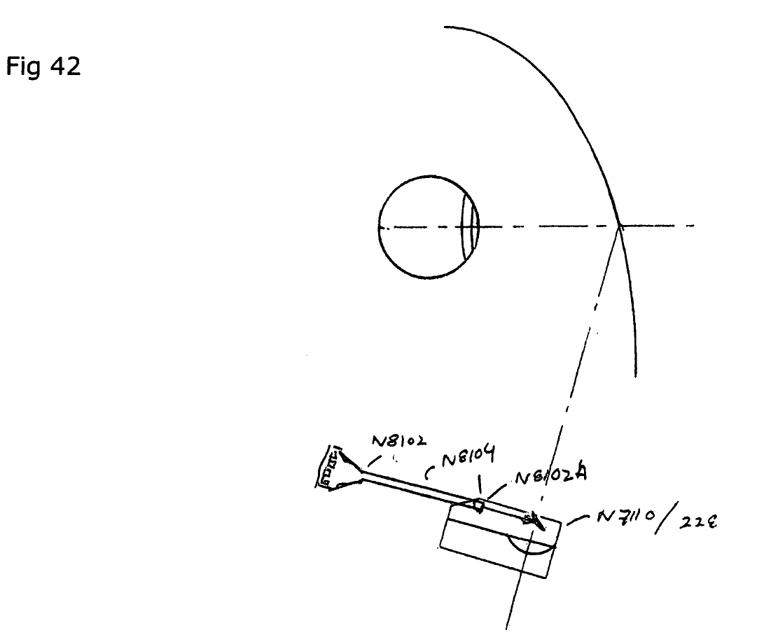

FIG. 42—Fiber optic transfer of emitter aperture--presents a preferred embodiment wherein the emitter and combiner exit aperture N8102, N8102A is transferred by means of an optical waveguide N8104 to the focal distance optical element N7110 or projection optics 228. Various shapes of waveguides including micro-optical elements may be employed.

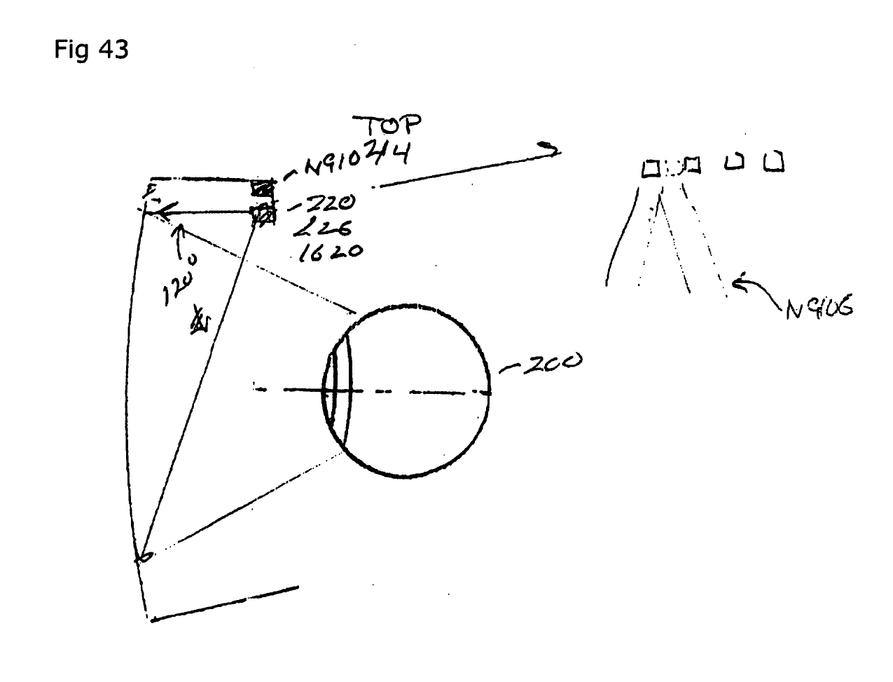

FIG. 43—Linear Construction Details (vertical scan) presents a preferred embodiment wherein the principal elements are arranged as a linear array N9102 with a vertical scan N9104. It may be understood that the present invention may be applied to alternative constructions, orientations, spacing, and shapes including but not limited to horizontal, oblique, curved or discontinuous arrays and scans.

Multiple linear LEE arrays of LEDs or FLCD shutters with tri-color LED illumination 220 with a center to center spacing of 12 microns (.mu.m) is placed perpendicular to the visor above the line of vision of the observer 200. A corresponding integrated linear scanning element array 226 and focal distance optical element 1620 with dimensions 10.times.50 .mu.m, if a membrane is used is positioned adjacent to the LEE array 220. Each emitter 220 projects a solid angle having a vertical scan over the vertical field of view (approximately 120.degree.) and a horizontal projection of approximately 20.degree . . . The resulting construction fabricated as a chip-on-board component would have dimensions of 12 .mu.m times 1024 or approximately 12 mm in length by 3 mm in width.

Multiple parallel sectors N9102 may be incorporated and multiple parallel membrane modulators. N9104. Multiple sectors may be offset.

Inset on FIG. 43 shows the offset projection N9106.

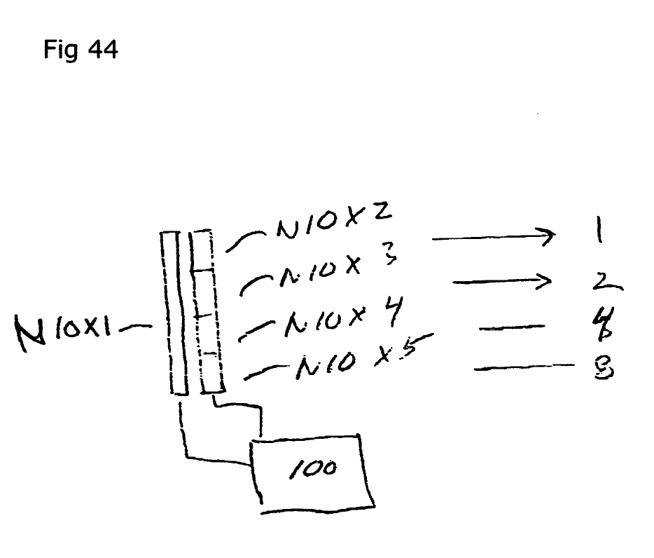

FIG. 44 presents a method for the efficient output from digital optical systems where the global intensity of the optical output may be synchronized with the digital pixel control. In previous operations, a light source N10×1 illuminates a number of digital pixel shutters N10×2-5 which are grouped together to form a single visual pixel. To achieve a value of 32, each pixel is on for the indicated number of period up to the cycle maximum of 8.

In the present invention, the intensity of the light source varies during the cycle maximum of 8 periods by the binary increments of 1, 2, 4, 8 . . . . Each pixel is illuminated for 0 to 8 periods resulting in varying intensities of 0-255 and an individual pixel density increase of a factor of 4. The base two series may be expanded to any power.

ADDITIONS: Composite linear array having:

pixel LEE driven analog

pixel LEE driven digital

group pixel LEE driven analog

group pixel LEE driven digitally

additive

binary intensity sequence

with integrated color

with distinct color

vertical scan

horizontal

with TIR visor optic

color separation

image enhancement

by F/LCD shutter

by static directed prismatic

variable ambient occlusion

forming TIR layer

with separator from TIR

integrated eye-tracker

horizontal FDOE

vertical FDOE

With TIR Screen

With FDOE enabled

With FD corrected for TIR

with dynamic HOE visor optic

HMD with image generated in ear arm and optically bent by TIR at the arm-visor junction

HMD as Personal Communicator

HMD with Dynamically Focusable Transmissive External View Lens

FIG. X1 shows a perspective view of the combined system A10 having a light emitting element (LEE) array A110, scanning optics A120 in the form of a two-axis, reflective scanner, and a partially reflective, micro-optical element visor or screen A300. The LEE array A110 and scanning optics A120 are controlled by computer assembly A90. Common to all head mounted displays and well known to those skilled in the art are a power source such as a battery A90B and a data receiving channel such as a television broadcast decoder or other data link. These are usually incorporated in the computer assembly A90 and therefore not shown separately.

In operation, the light beams A200, A200′ (shown by single and double arrows respectively) from one of the LEE array elements A110x are cyclically scanned by the two-axis (vertical A120v and horizontal A120h), reflective scanner A120 across the partial reflective visor A300. The reflected beams A200, A200′ directed towards the observer's eye A22 which, when in focus converge as a single point on the retina A22′. As is common in augmented reality systems, the partial reflective screen A300 also permits the observer to view the external environment A304. The percentage of reflectivity is commonly controllable by a number of well-known technologies including but not limited to LDC shutters. By scanning the entire screen at 30 frames per second, a stable, full virtual image A3 10 over a wide field of view is presented.

To the observer, the apparent distance between oneself and a light emitting element A110′ is a function of the design focal length of the system which includes the focal lengths incorporated in the visor A300, the scanner A120, and the LEE array A110. Commonly, HMDs are set at about 12 feet. In a preferred embodiment of the present invention, the LEE array A110 is co-axial with the principal optical axis of the system and along this axis, the distal LEE element A110″ is further away than the proximal LEE element A110′″. As a result, the LEE elements A110 will each focus at a different virtual distance A3 10, and they may be simultaneously illuminated.

In my earlier inventions disclosed in U.S. patent application Ser. No. 07/779,066 and subsequent applications, co-axial image points could only be presented sequentially in time. One of the significant advantages of the present invention is that a multiplicity of co-axially elements may be simultaneously illuminated. In defense, medical and other applications where multiple targets frequently align co-axially, the present invention increases image comprehension and accuracy while improving the reaction time.

FIG. X2 shows the present invention with a two-dimensional (7×3), light emitting element array A110D. It may be understood that the size of the array is generally 4096×1024 and the virtual image 640-4096×1024. Two advantages of this preferred embodiment are the simplification of the scanner A120 from two-axis to one A120H, and reduction in the required frequency of illumination of the individual light emitting elements A110 for a given image resolution. While FIG. X2 shows the placement of the light source and scanning assembly A100 on the side of the head, any placement may be employed including but not limited to on the top or bottom of the head, on the cockpit dashboard, or a desktop.

Displays with visual accommodation produce an image by scanning a divergent beam from each image pixel directly into the field of view of the observer rather than forming a real image on a screen or surface, though embodiments may not implement the attribute. In the natural environment, the divergent beam is generally circular orthogonal to the principal axis between the center of the observer's eyelens and the originating image pixel. However, under certain natural and normal circumstances, including the polarized reflections from the surface of a body of water, beam may be elliptical or linear. Nonetheless, human visual accommodation is able to respond accurately.

A number of display configurations and technologies including those enabling visual accommodation may be enhanced, both in performance and manufacturability, by projecting a linear form of the divergent beam.

In my earlier patent applications including Ser. No. 7/799,066, I disclosed improvements to the well-known waveguide wedge taught in U.S. Pat. Nos. 4,212,048 by Donald Castleberry and 4,109,263 by Bruce Johnson of the Polaroid Corporation of Cambridge, Mass. Mr. Johnson was a co-employee of my colleague at MIT and Woods Hole, and his total internal reflection camera was often used as a visual display screen with a ground glass focusing element in place of the film. Both natural and projected images were used. My referenced enhancements have also been the subject of discussions with collaborators at MIT Professors Stephen Benton and Cardinal Ward.

While the application of the Johnson Wedge was well-known at MIT, it application was limited to the compactness of the optical path in connection with reprojection of the image from an often diffusive screen in the Johnson film plane. This is in part due the substantial different optical path lengths and visual focal distance between the display exit pixels at the base and tip of the wedge.

This preferred embodiment of the present invention addresses the application of the Johnson Wedge to devices which maintain the optical focal distance to the LEE.

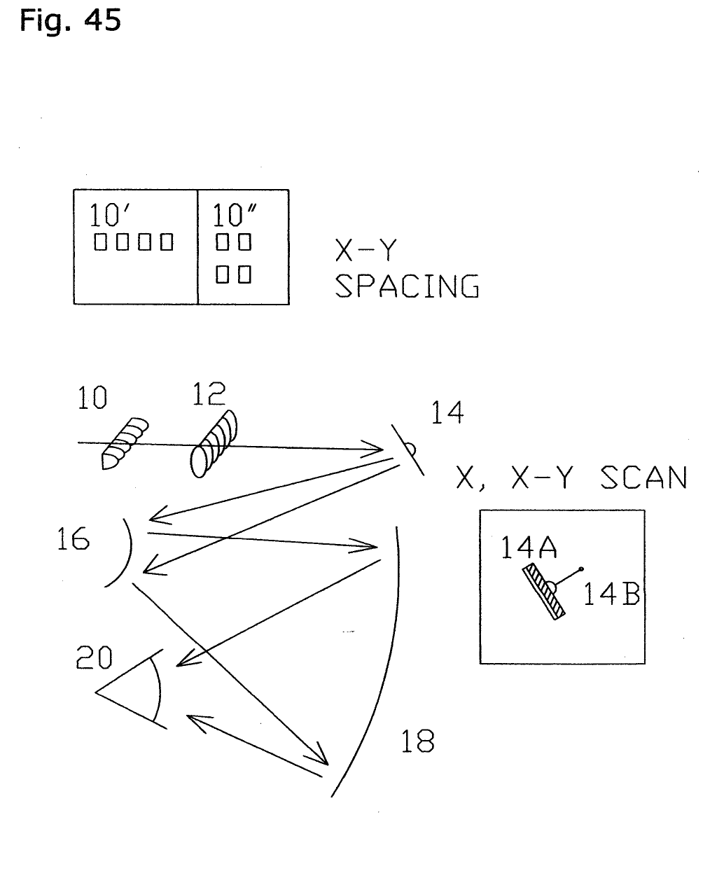

FIG. 45 shows a preferred embodiment having a light source 10, variable focal length element 12, a first scanning element 14, a first optical element 16 and a visor optical element 18. In operation, the light source 10 is focused by focal length element 12 and scanned by scanning element 14 onto the first optic 16 and then onto the visor optical element 18. The first optical 16 causes the virtual position of the light source to displace, which is expanded by the proper complementary visor optics as viewed by the observer. This embodiment expands the visual aperture of the HMD.

Complementary optics includes various combinations of circular, parabolic, and elliptical forms. One example shown is a circular first optic 16 and an elliptic visor optic 18. Corrections for 1^{st} and 3^{rd} order aberrations may be introduced. Factors such as field of view, precision, scanning control and light source modulation may determine the optimum design for a given market.

Eye position feedback may be used to adjust the image for placement, registration with the external environment, or distortion.

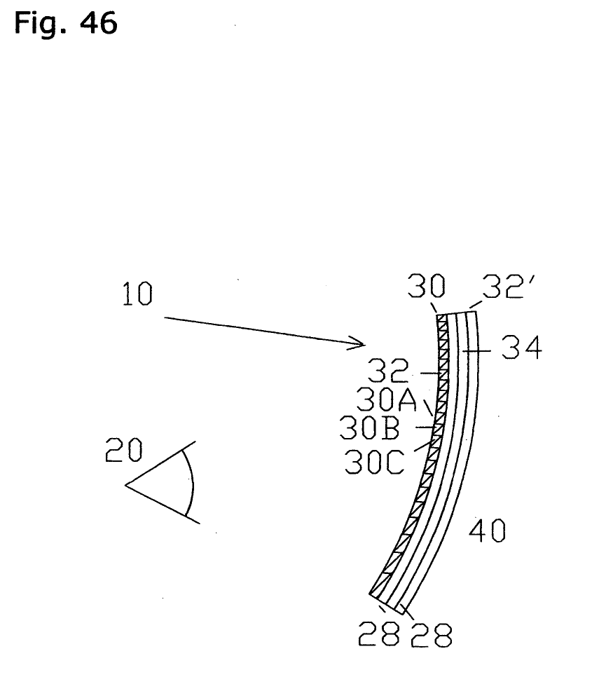

The embodiment disclosed in FIG. 46 is described in large part in my earlier and pending applications, which integrate the scanning and first optic properties by displacing the reflective surface of the scanning element 14, which may be but is not limited to a resonant mirror, from the axis of rotation. This naturally occurs with a polygon scanner.

It may be noted that the observer aperture is determined in part by the relative size of the light source aperture (pixel) and the virtual position displacement caused by the scanning optics. Thus, a wide observer aperture dictates a small light source and a larger virtual displacement.

FIG. 46 shows a preferred embodiment having an active, augmented-reality visor optics 28 having a reflective prismatic form 30, a liquid crystal medium 32 and an external substrate. In operation, the reflective forms 30a-c are sequentially switch from reflective to transmissive in coordination with the scanning of the light source 10. The ratio of reflective to transmissive periods determines the occlusion of the ambient environment. A second liquid crystal and substrate 40 may be employed to increase the occlusion of the ambient environment. The polarization optics for occlusion are not shown, but commonly understood in sequential shutter stereoglasses such as those used by IMAX or manufactured by Stereographics.

The active visor optics 28 complements and may be applied to the embodiments in my pending applications.

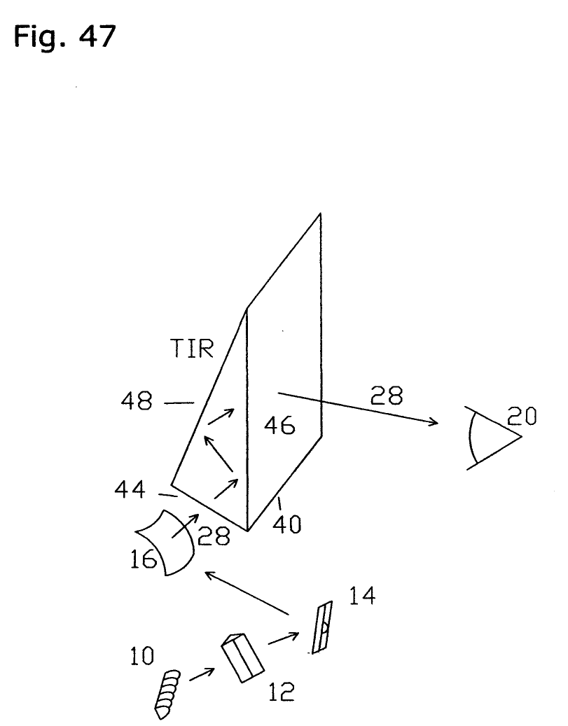

FIG. 47 shows a preferred embodiment applied to the Johnson art of total internal reflector where the beam(s) 28 from one or more light sources 10 including but not limited to a linear array are modified by a focal length element 12 and scanned by scanner 14 which may included a displacement reflector 16 into the Johnson prism 40. With the prism 40, the beam is totally internally reflected one or more times between the exit face 46 and the prism face 48, finally exiting when the intersection with the exit face 46 is more than the critical angle, to the observer 20. A redirecting optical element 60 is shown in FIG. 4 which may be diffuser, fresnel lens, micro-optic lens, HOE or other optical element depending on the use, (HMD, NTE, heads up display, screen) and position(s) of the observer(s).

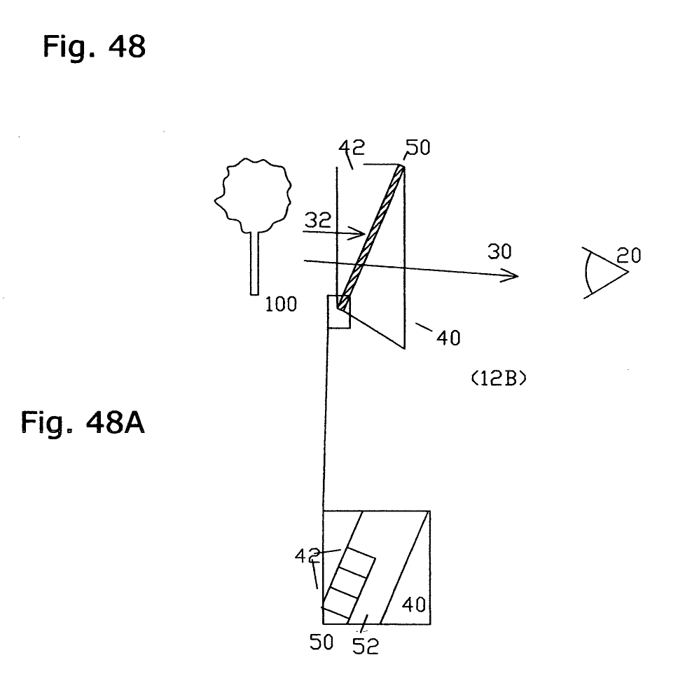

FIG. 48 shows a second prism 42 proximal but spaced from the first prism 40 which directs the light from the environment 100 through the first prism 40 to the observer(s) 20. Interposing between the prisms is a shutter system 50 (which may be but is not limited to liquid crystal shutters, electrophoretic, electro-optic, MEMS or other systems) configured and activated as rows, columns or both. In operation, the shutter acts to occlude the external environment 100 and increased the contrast of the projected ray 30. The shutter 50 may act in synchrony with the scanning system 14.

FIG. 48a shows that the shutter system 50 may be placed next to the second prism 42 with a space 52 between the shutter and the first prism 40. When used with LCD, electro-optics or acousto-optics the change in the refractive index may alter the critical angle or reflectivity, or evanescent coupling, thereby increasing resolution and contrast. Alternately, the shutter system 50 may be spaced from both prisms.

FIG. 49 shows that the shutter system 50 may be able to the observer face 50′ or the environment face 50.

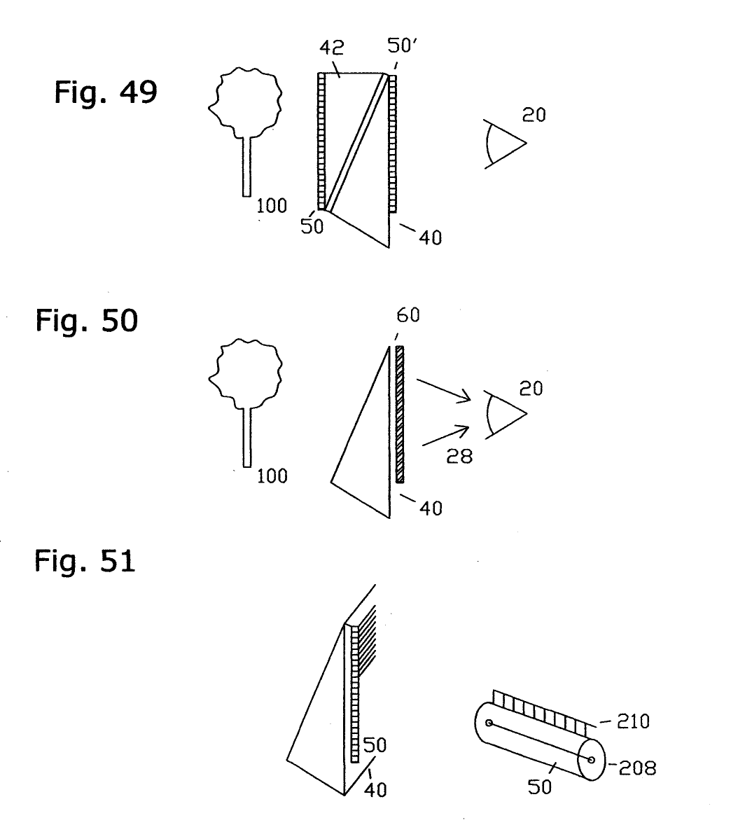

FIG. 50 shows a redirecting optical element 60 which may be diffuser, fresnel lens, micro-optic lens, HOE or other optical element depending on the use, (HMD, NTE, heads up display, screen) and position(s) of the observer(s).

FIG. 51 shows a method of manufacturing the linear array shutter system where the shutter material (LCD, for example) 50 is applied to a film which is placed on roll 208 and serially sliced 210 (etched by laser, for example.)

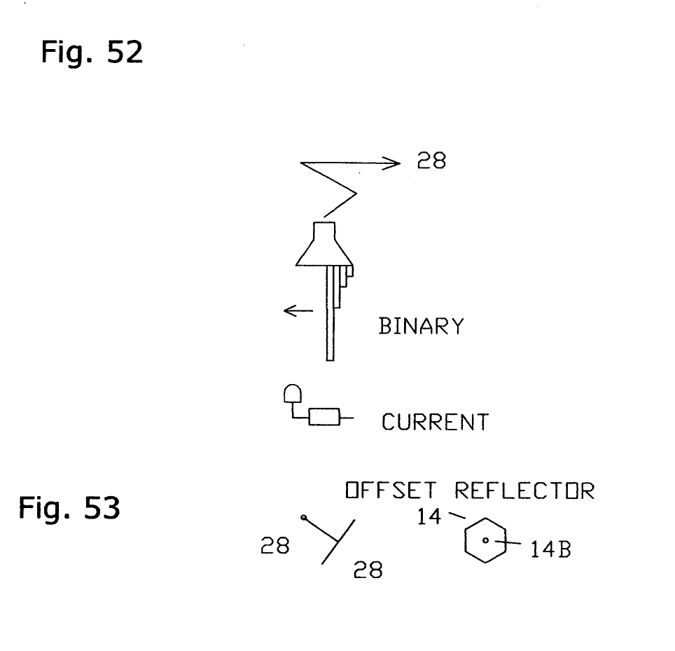

FIG. 52a shows a binary intensity array of light sources which when energized simultaneously may produces wide intensity range.

FIG. 52b shows a current control system for the light sources which when energized simultaneously may produces wide intensity range.

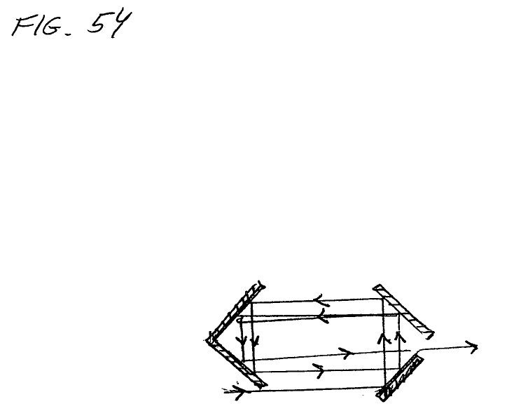

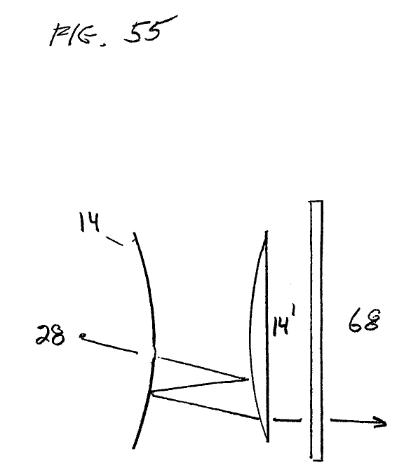

FIG. 53 shows the offset embodiment for the scanner.

FIG. 54 shows a variable distance, folded optics where the light source is reflected by scanner 14 to the entrance aperture 64 and internally reflected by slight skewed right reflectors/prisms 14′, 14″ and output at exit aperture 62.

FIG. 55 shows the right reflector 14′, 14″ may be curved to produce a broaden image 68 from the input image 28.

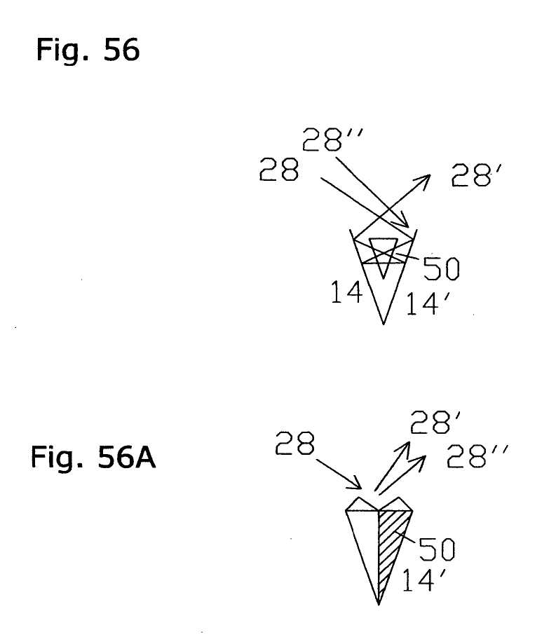

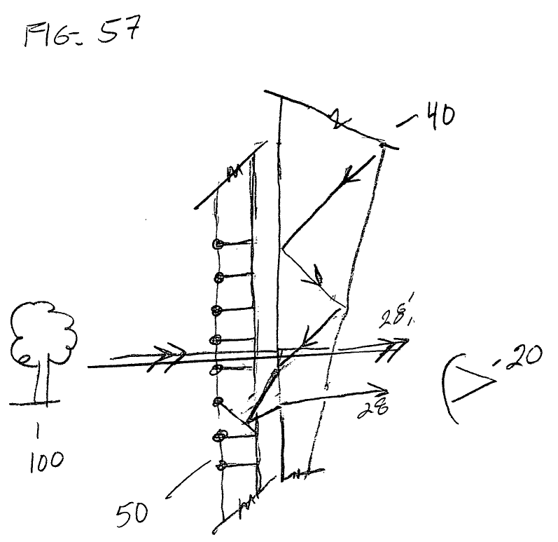

FIG. 56 shows a solid-state scanner having reflective faces 14, 14′ and a LC (liquid crystal, or other transparent refractive index modulator) core 50. The input beam 28 traverses the core 50, reflects from surfaces 14, 14′ and exit as beam 28′ or 28″. The number of reflections and the exit angle is varied by changing the refractive index of the core 50.

FIG. 56A shows an alternative solid-state scanner where the LC region 50 is proximal to one reflective face 14′.

FIG. 57 present an active shutter reflector element 50′ which may finction as the redirecting optics 1350 as shown in FIG. 13 and FIG. 50, one or more shutter systems 50, 50′ may be incorporated with a redirecting optic 60 placed before or after. When the shutter system 50′ is in between the observer the prism exit face 46 it may additionally finction to increase the resolution, shown as vertical lines but not limited to any direction, of the beam by masking the adjacent regions 50a, b, c, when opened in synchrony with the scan. The scans may be interlaced (alternating patterns).

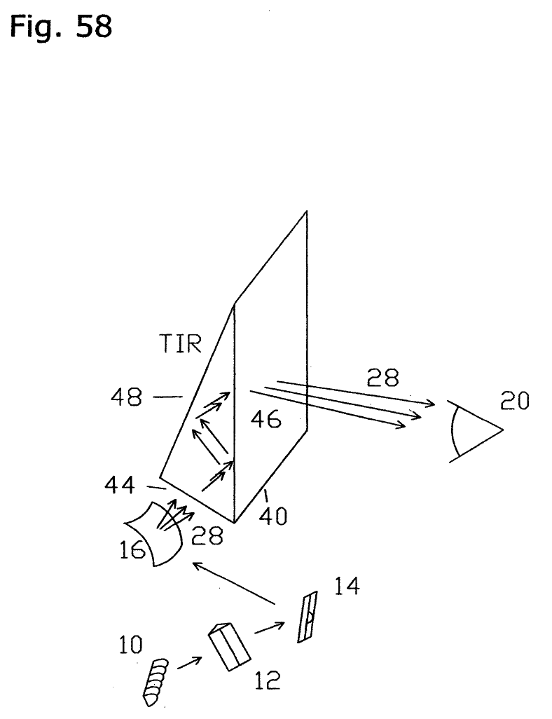

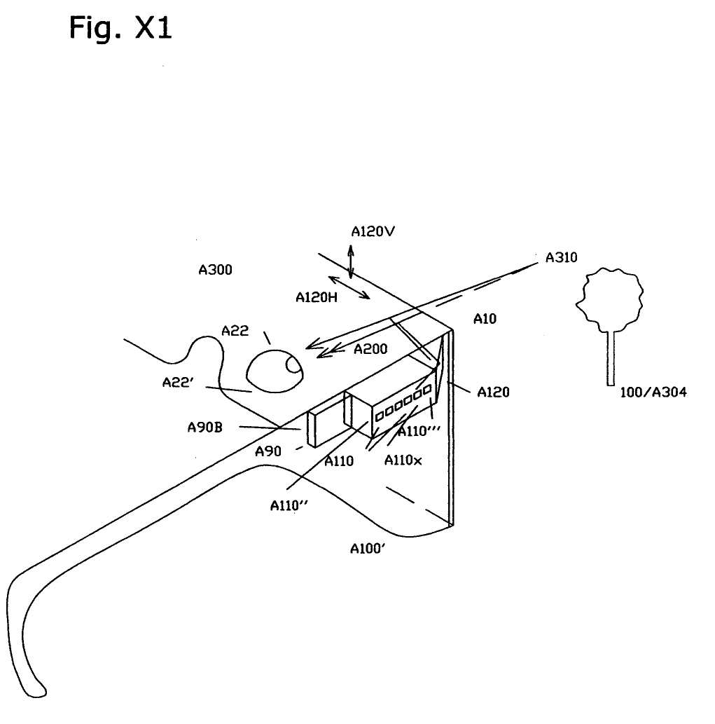

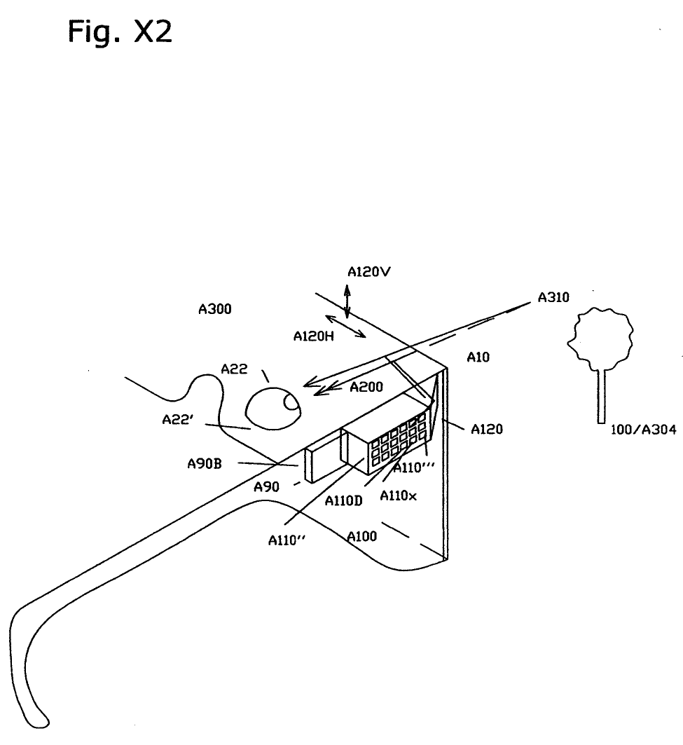

FIG. 58 present a linear accommodation embodiment where the LEE array 10 projects a fan shaped beam 28,28′,28′″ from each pixel. When the fan beam 28 is perpendicular to the wedge axis of TIR prism 40, the optical path lengths are symmetrical about the principal axis of the beam 28 and facilitate visual accommodation. Further the necessary optics are simplified and the resolution of the system improved.

Chromatic control may be integrated or distinct, with separate LEEs for each color. While RGB combinations are well-known, additional colors including yellow, amber and purple may be included.

Accurate accommodation requires the adjustment of the base level for objects in the system. Thus an virtual object designed to by at 1 meter will require focal distance adjustment as it moves from the along the wedge axis. A LUT may be provided in the software to introduce the correction.

The shutter element 50 may be optically-active materials such as liquid crystal, (LC, FLC), dyes, or displaceable elements such as micro-mirrors, electrophoretic spheres, piezo-vanes, etc. While the embodiment shown places the LEE and prism vertically, the orientation may be horizontal or oblique. The TIR pathway may begin in the ear arm of a pair of eyeglasses and bend around the comer. The visor, LEE and other components may be curved or conform to a unique shape.

The embodiment of the invention particularly disclosed and described herein above is presented merely as an example of the invention. While the present invention is presented in a binocular environment, the novel elements may be applied to monoscopic or polyscopic devices, head mounted, near to eye, immersive, planar, television and cinema configurations. Other embodiments, forms and modifications of the invention coming within the proper scope and spirit of the appended claims will, of course, readily suggest themselves to those skilled in the art.

Claims:

1. A visual display system comprising:
light emitting element array means for projecting one or more pixels of a full image
optical scanning means for displacing the optical radiation from the light emitting elements means across the field of view;
screen means for projecting the optical radiation from the light emitting elements means toward the observer's eye;
computational means for calculating the light emitting element of the light emitting element array means corresponding to the designated distance of the respective pixel in the projected virtual image; and
controller means for synchronizing the modulation of the light emitter element array means and optical scanning means.

2. A visual display system comprising:
light emitting element array means for projecting one or more parts of a full image wherein at least one dimension of said light emitting element array means is co-axial with the principal optical axis of the visual display system;
optical scanning means for displacing the optical radiation from the light emitting elements means across the field of view;
screen means for projecting the optical radiation from the light emitting elements means toward the observer's eye;
computational means for calculating the light emitting element of the light emitting element array means corresponding to the designated distance of the respective pixel in the projected virtual image; and
controller means for synchronizing the modulation of the light emitter element array means and optical scanning means.

3. A visual display system in accordance with claim 10 wherein said light array means includes light emitting diodes.

4. A visual display system in accordance with claim 10 wherein said light array means includes a transparent light emitting medium modulatable by an external source.

5. A visual display system in accordance with claim 12 wherein said transparent light emitting medium is modulated by two-photon up conversion.

6. A visual display system in accordance with claim 10 wherein said light array means describes a volume corresponding the field and depth of view of the virtual image.

7. A visual display system comprising:
Light emitting element array means for projecting one or more parts of a full image;
focus optical means for providing optical focal distance for each element of the light emitting element array means;
optical scanning means for displacing the optical radiation from the light emitting elements means across the field of view;
screen means for projecting the optical radiation from the light emitting elements means toward the observer's eye; and
controller means for synchronizing the light emitter element means, variable focus optical means and optical scanning means.

8. A visual display system in accordance with claim 15 further wherein said variable focus optical means is an array of deformable membrane mirrors corresponding to and of equal number to the light array means.

9. A visual display system comprising:
light emitting element array means for projecting one or more parts of a full image;
interlacing means for providing a sub-element illumination pattern transduce-able into a full virtual image of increased pixel number and density;
optical scanning means for displacing the optical radiation from the light emitting elements means across the field of view;
screen means for projecting the optical radiation from the light emitting elements means toward the observer's eye; and
controller means for synchronizing the light emitter element means, interlacing means and optical scanning means.

10. A visual display system in accordance with claim 19, wherein said interlacing means are comprised of fiber optics.

11. A visual display system in accordance with claim 19 further comprising focus optical means for providing optical focal distance for each element of the light emitting element array means.

12. A visual display system in accordance with claim 10 further comprising eye state feedback means for providing said controller means data to conform the modulation of said light array means and focus optical means to the observer's eye state.

13. A visual display system in accordance with claim 15 further comprising eye state feedback means for providing said controller means data to conform the modulation of said light array means and focus optical means to the observer's eye state.

14. A visual display system in accordance with claim 19 further comprising eye state feedback means for providing said controller means data to conform the modulation of said light array means and focus optical means to the observer's eye state.
